(19) United States
(12) Patent Application Publication
(10) Pub. No.: US 2026/0260578 A1
(43) Pub. Date: Sep. 3, 2026

(54) KIT, SYSTEM AND METHOD FOR TRAINING USING ANATOMIC SIMULACRA

(71) Applicant: Arthrex, Inc., Naples, FL (US)

(72) Inventors: Jesus Sevillano, Naples, FL (US); Andrew Claassen, Naples, FL (US); Nick Metcalfe, Bonita Springs, FL (US); David Knopf, Bonita Springs, FL (US)

(73) Assignee: Arthrex, Inc., Naples, FL (US)

(21) Appl. No.: 19/555,586

(22) Filed: Mar. 3, 2026

Related U.S. Application Data
(60) Provisional application No. 63/765,940, filed on Mar. 3, 2025.

(51) Int. Cl. G09B 19/00; G09B 23/30

(52) U.S. Cl. CPC G09B 19/00; G09B 23/30

(57) ABSTRACT

A kit, system and method for a surgical training procedure that uses at least one polymer-based anatomic simulacra. In one example, the kit for a surgical training procedure includes at least one polymer-based anatomic simulacra that corresponds to a portion of an anatomy. The kit also includes at least one instrument configured to perform at least a portion of a surgical training procedure on the at least one polymer-based anatomic simulacra.

### CROSS-REFERENCE TO RELATED APPLICATION

This application priority to and the benefit of U.S. Provisional Application No. 63/765,940 filed on March 3, 2025. The disclosure of the above application is incorporated herein by reference.

### BACKGROUND

The present disclosure relates to medical devices and methods for surgical training, and more particularly relates to a kit, a system and a method for surgical training using polymer-based anatomic simulacra.

Generally, surgical procedures may be practiced using a cadaver specimen. Cadaver specimens, however, require refrigeration along with special handling and disposal. In addition, cadaver specimens may have inconsistent quality due to freezing and thawing cycles, and the bone density may vary. Further, the mounting of cadaver specimens to practice a surgical procedure may be limited due to the nature of the particular cadaver specimen.

### SUMMARY

This section provides a general summary of the disclosure and is not a comprehensive disclosure of its full scope or all of its features.

The present disclosure provides a kit, a system and a method for training using polymer-based anatomic simulacra. The kit, the system and the method may include various polymer-based anatomic simulacra, which enable one or more surgical procedures to be practiced for training purposes. The anatomic simulacra may be formed using additive manufacturing techniques, such as three-dimensional (3D) printing or may be cast.

In one example, a kit for a surgical training procedure includes at least one of the polymer-based anatomic simulacra that corresponds to a portion of an anatomy. The kit also includes at least one instrument configured to perform at least a portion of a surgical training procedure on the at least one polymer-based anatomic simulacra.

The at least one polymer-based anatomic simulacra includes a plurality of anatomic simulacra. Each anatomic simulacra of the plurality of anatomic simulacra has at least one characteristic. The at least one characteristic is selected from the group including a density, a porosity, a simulated age, a fracture pattern, a pathology and combinations thereof. The at least one polymer-based anatomic simulacra includes at least one synthetic anatomical joint. The kit further includes a fixture configured to couple the at least one polymer-based anatomic simulacra to a workspace. The kit includes at least one check fixture configured to determine an accuracy of the surgical training procedure. The kit further includes at least one implant configured to be coupled to the at least one polymer-based anatomic simulacra. The at least one instrument includes a plurality of instruments, with one of the plurality of instruments including a sensor system configured to observe the one of the plurality of instruments.

In another example, the kit for a surgical training procedure includes at least one anatomic simulacra that corresponds to a part of an anatomy, at least one instrument and a personal electronic device. The personal electronic device has a processor configured to output instructions to perform at least a portion of a surgical training procedure on the at least one anatomic simulacra using the at least one instrument.

The personal electronic device includes a display, and the processor is configured to output the instructions on the display. The at least one anatomic simulacra includes a plurality of anatomic simulacra. Each anatomic simulacra of the plurality of anatomic simulacra has a characteristic, and each characteristic of the plurality of anatomic simulacra is different. The characteristic is selected from the group including a density, a porosity, a simulated age, a fracture pattern, a pathology and combinations thereof. The at least one anatomic simulacra includes a polymer-based anatomic simulacra. The at least one anatomic simulacra includes a polymer-based synthetic anatomical joint. The kit further includes a fixture configured to couple the at least one anatomic simulacra to a workspace. The kit includes a cleaning system configured to remove debris associated with the surgical training procedure. The kit further includes a fluid management system configured to irrigate the at least one anatomic simulacra during the surgical training procedure. The kit includes a check fixture configured to determine an accuracy of the surgical training procedure. The check fixture is configured to receive at least a portion of the at least one anatomic simulacra to determine the accuracy of the surgical training procedure. The kit includes a tracking system configured to output one or more signals indicating a global position of the kit. The kit includes a surgical optical system configured to communicate with the personal electronic device and to output an image data stream during the surgical training procedure. The processor is configured to output the image data stream from the surgical optical system on the display associated with the personal electronic device. The kit includes at least one implant configured to be coupled to the at least one anatomic simulacra. The at least one instrument includes a plurality of instruments, with one of the plurality of instruments including a sensor system configured to observe the one of the plurality of instruments.

A system for surgical training includes the kit, and the kit includes at least one anatomic simulacra that corresponds to a part of an anatomy, at least one instrument and a personal electronic device. The personal electronic device has a processor configured to output instructions to perform at least a portion of a surgical training procedure on the at least one anatomic simulacra using the at least one instrument. The system includes a remote system configured to communicate with the personal electronic device.

The remote system is configured to communicate an image data stream to the personal electronic device, and the processor is configured to output the image data stream on a display associated with the personal electronic device as the instructions regarding the surgical training procedure. The remote system includes at least one of a remote personal electronic device, a computing device associated with a surgical system and a robot. The remote system includes a display, and the remote system is configured to display the instructions.

Also provided is a method for surgical training. The method includes providing at least one anatomic simulacra that corresponds to a part of an anatomy and at least one instrument configured to perform at least a portion of a surgical training procedure on the at least one anatomic simulacra, and retrieving, by a controller, the surgical training procedure based on the at least one anatomic simulacra. The method includes outputting, by the controller, the surgical training procedure for display on a display, and observing, by the controller, a performance of the surgical training procedure.

The retrieving the surgical training procedure based on the at least one anatomic simulacra further includes receiving, by the controller, a joint selection associated with the at least one anatomic simulacra; retrieving, by the controller, at least one available language and at least one available surgical training procedure based on the joint selection; and receiving, by the controller, a language selection and a selection of the surgical training procedure. The outputting the surgical training procedure for display on a display further includes outputting each procedural step associated with the surgical training procedure on the display. The observing the performance of the surgical training procedure further includes receiving, by the controller, observation data from at least one of a sensing system and a camera system for each procedural step; associating the observation with the procedural step; and storing the associated data as procedure step performance data in a datastore. The method further includes compiling, by the controller, the procedure step performance data for each procedural step as procedure performance data; and communicating, by the controller, the procedure performance data to a remote system. The outputting the surgical training procedure for display on a display further includes outputting the surgical training procedure for display on a display associated with at least one of a personal electronic device, a computing system of a surgical system, and a robot.

Further areas of applicability will become apparent from the description provided herein. It should be understood that the description and specific examples are intended for purposes of illustration and are not intended to limit the scope of the present disclosure.

### BRIEF DESCRIPTION OF THE DRAWINGS

In order that the disclosure may be well understood, there will now be described various forms thereof, given by way of example, reference being made to the accompanying drawings, in which:

FIG. 1A is a schematic illustration of a surgical environment.

FIG. 1B is a schematic illustration of a surgical system.

FIG. 1C is a functional block diagram of an exemplary system for surgical training using polymer-based anatomic simulacra, which includes an exemplary kit.

FIG. 2 is a schematic illustration of a use of the kit of FIG. 1C for surgical training.

FIG. 3 is a schematic illustration of one or more exemplary anatomic simulacra associated with the kit positioned within a case of the kit.

FIG. 4 is a functional block diagram of an exemplary instrument associated with the kit.

FIG. 5 is a dataflow diagram illustrating a surgical training control system of the kit of FIG. 1C, in accordance with various examples.

FIG. 6 is a schematic illustration of an exemplary user interface associated with a personal electronic device of the kit.

FIGS. 7A-7C are schematic illustrations of an exemplary surgical training procedure performed with the kit.

FIGS. 8-10 are flowcharts illustrating a method for the surgical training control system of the kit, in accordance with various examples.

FIG. 11 is a functional block diagram of another exemplary kit for surgical training using polymer-based anatomic simulacra.

The drawings described herein are for illustration purposes and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features. In addition, there is no intention to be bound by any expressed or implied theory presented in the preceding technical field, background, brief summary or the following detailed description.

As described, the present disclosure provides a kit, a system and a method for surgical training using polymer-based synthetic specimens, anatomical models or anatomic simulacra. The anatomic simulacra are used in the place of cadaveric specimens. The anatomic simulacra may be tailored to the anatomy of various patients, which enables a surgical trainee to practice a surgical procedure on a variety of different anatomical models. In addition, the anatomic simulacra may enable a predefined fracture pattern or repair procedure to be practiced, which may be difficult to practice otherwise. The kit, the system and the method may also enable the trainee's performance of the surgical procedure or surgical training procedure to be evaluated, and the evaluation may be used to award the trainee a certification in a particular surgical procedure and/or to rank or score the trainee relative to other participants in the surgical training procedure. It should be noted that while the kit, system and method are described herein as being used with a surgical training procedure that simulates a surgical procedure, it should be understood that the kit, the system and the method may also be used to practice a surgical technique, or a portion of a surgical procedure, and thus, the present disclosure is not limited to practicing a surgical procedure in its entirety.

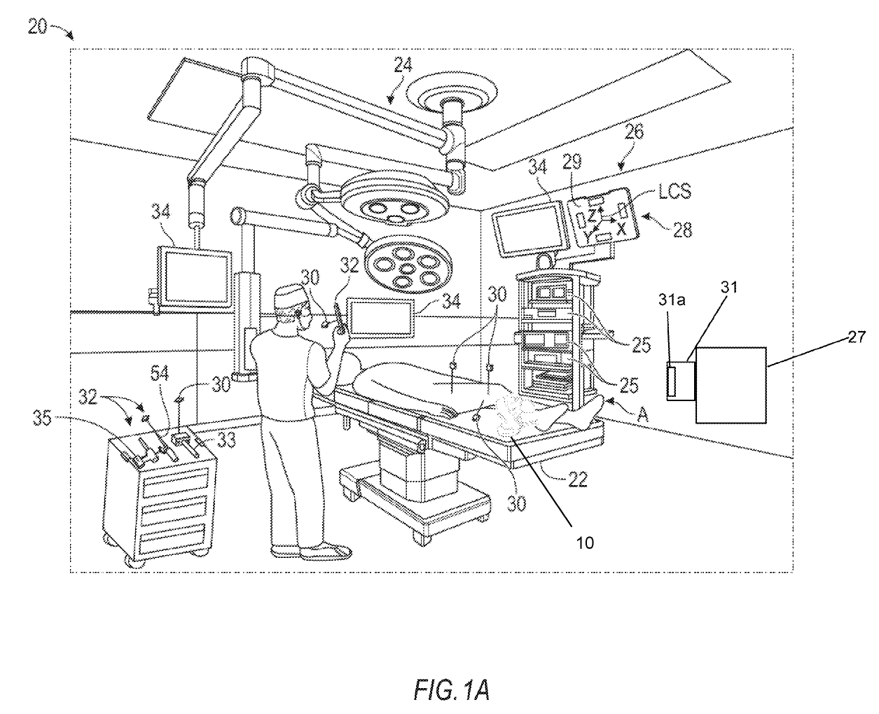

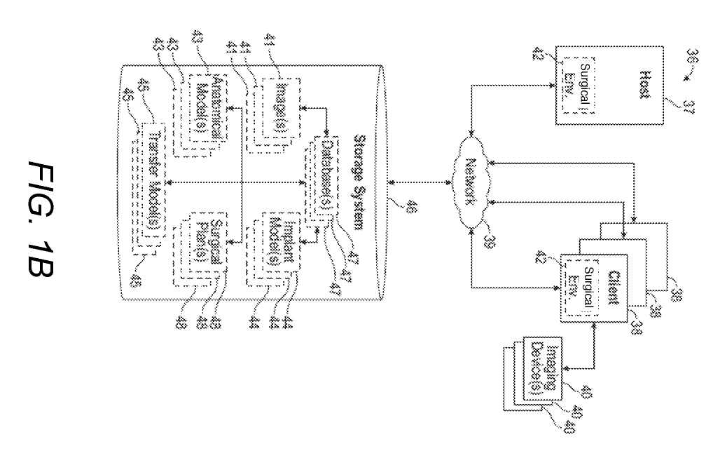

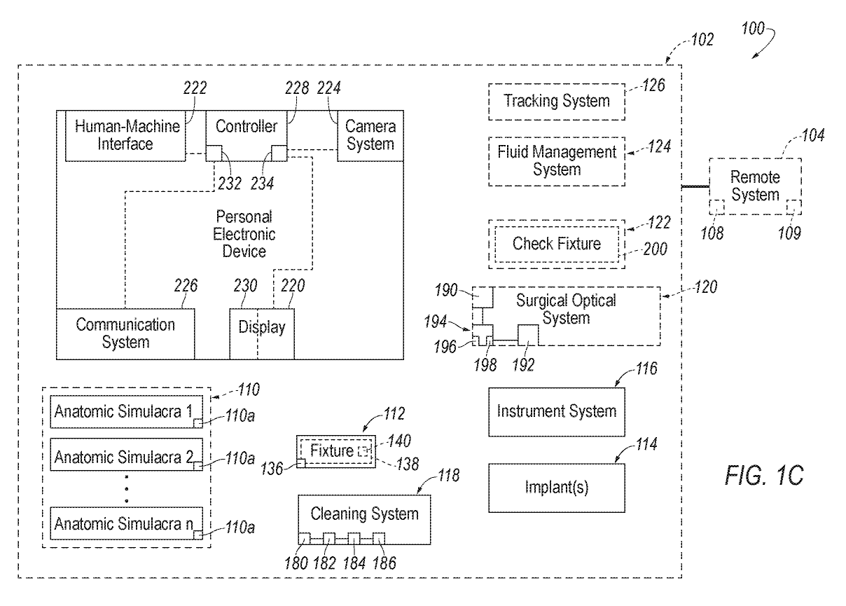

FIG. 1A may provide a surgical suite (e.g., system or assembly) 20 according to an implementation. The surgical suite 20 may be utilized to perform various surgical procedures (e.g., manual surgical procedures, robotic-assisted surgical procedures, surgical training procedures), including but not limited to, an orthopedic procedure such as an arthroscopy or an arthroplasty to restore functionality to one or more bones and/or joints. The surgical procedure may include repair of one or more characteristics associated with a patient. For example, the surgical procedure may include repair of one or more bone pathologies (e.g., defects) associated with a bone of a patient. The surgical procedure may include repair of one or more soft tissues such as a damaged muscle, ligament, tendon or the like. The suite 20 may be utilized in the repair of various locations of the anatomy and other surgical procedures including repair of joints such as the shoulder, foot, ankle, wrist, hand, hip, knee, and spine. The suite 20 may also be used in a surgical training procedure to repair an anatomic simulacra 10. The anatomic simulacra 10 may comprise an anatomic simulacra 110 described below.

The suite 20 may include an operating table 22 for supporting an anatomy A of a patient and/or the anatomic simulacra 10 as will be described below. The suite 20 may include a light assembly 24, which may include one or more light sources for communicating light towards the patient anatomy A and/or the anatomic simulacra 10.

The suite 20 may include one or more computing devices 25. The computing device(s) 25 may include (e.g., processing) circuitry, including one or more processors coupled to memory, input devices, and/or output devices. The processor(s) may be collectively operable to perform any of the functionality disclosed herein. The computing device(s) 25 may be operable to establish a surgical plan and/or implement the surgical plan for treating the patient. The computing device(s) 25 may be operable to establish a surgical training procedure involving the anatomic simulacra 10.

The suite 20 may include an equipment tower 26. The equipment tower 26 may include one or more modules (e.g., systems), which may incorporate the computing device(s) 25. The module(s) may include a guidance (e.g., navigation or tracking) module 28. The guidance module 28 may include a localizer 29, which may be operatively coupled to the computing device(s) 25. The localizer 29 may include a sensor unit having one or more sensors. One or more trackers 30 may be situated (e.g., fixed or secured) relative to the patient anatomy A and/or the anatomic simulacra 10. The trackers 30 may comprise an anatomy tracker. The trackers 30 may include one or more objects (e.g., markers). The trackers 30 may include active devices (e.g., sensors or light emitting diodes) and/or passive devices (e.g., reflectors). The tracker(s) 30 may be placed relative to the anatomy A, the anatomic simulacra 10 and/or one or more surgical devices (e.g., instruments) 32. The devices 32 may include any of the devices disclosed herein. The devices 32 may include one or more surgical guides 33, cutting instruments 35, and/or surgical probes 54. The tracker(s) 30 may be placed relative to one or more landmarks of the anatomy A and/or the anatomic simulacra 10. The surgeon or clinical user may manipulate the surgical devices 32 during a surgical procedure. The localizer 29 may be operable to determine (e.g., track) the position and/or orientation of the trackers 30. The guidance module 28 may be operable to determine the position and/or orientation of each tracker 30 with respect to a (e.g., localizer or global) coordinate system (e.g., framework) LCS of the localizer 29. The suite 20 may be operable to transfer coordinates in the coordinate system LCS to another coordinate system (e.g., framework), such as a local coordinate system of a surgical device 32 or a coordinate system associated with a surgical planning system, and/or vice versa, using various transformation techniques.

The suite 20 may include one or more displays 34. The computing device(s) 25 may be operable to cause the display(s) 34 to display various data and/or information associated with a patient, including a surgical plan and/or guidance information. A surgeon or clinical user may interact with the display(s) 34. The guidance module 28 may be operable to cause the display(s) 34 to display a position and/or orientation of the tracker(s) 30 and/or associated surgical device(s) 32 relative to the anatomy A of the patient and/or the anatomic simulacra 10.

The suite 20 may include a robot 27, which may be in communication with the computing devices 25. The computing devices 25 may be operable to control the robot 27. In some examples, the computing devices 25 may cause the robot 27 to perform a portion or all of a surgical procedure or surgical training procedure. In some examples, the computing devices 25 may be used to control the robot 27 to evaluate one or more characteristics of the patient and/or target anatomy. In other examples, the computing devices 25 may be operable to validate a movement of the robot 27 relative to the anatomic simulacra 10.

The robot 27 may be used to assist with and/or perform a surgical procedure, a training procedure, or both. In some examples, the robot 27 may be a hand- held robot. In some other examples, the robot 27 may include a robotic arm 31. The robot 27 may include a base and an end effector 31a operatively coupled with the base. The robot 27 may include one or more actuators to move the end effector 31a, the base, or both. The end effector 31a may comprise a working end of the robot 27, and may include a proximal portion to be operatively coupled to the base, and a distal portion that includes a surgical instrument or tool. The distal portion of the end effector 31a may include, but is not limited to, a burr, a drill, a probe, a saw, a medical device, a measuring device, one or more sensors, a microscope, a camera, a light, an endoscope, an ultrasound probe, an irrigation device, a suction device, a radiotherapy device, and/or any other instrument or tool useful for surgery, surgical planning, and/or surgical navigation. In one example, the anatomic simulacra 10 may be used to validate or verify an accuracy of a movement of the robotic arm 31 prior to the performance of the surgical procedure. The robot 27 may include a display.

FIG. 1B may provide a surgical (e.g., planning or guidance) system (e.g., assembly) 36 according to an implementation. The surgical suite 20 may incorporate and/or may interface with the surgical system 36. The surgical system 36 may be utilized for planning and/or executing orthopedic and/or other surgical procedures, including pre-operatively, intra-operatively and/or post-operatively to create, edit, execute and/or review surgical plans. The surgical system 36 may be utilized for various orthopedic and other surgical procedures, including any of the procedures disclosed herein. The surgical system 36 may be utilized in the design and/or placement of various surgical constructs (e.g., devices). Surgical constructs may include any item assembled and/or placed in the patient anatomy A and/or the anatomic simulacra 10 during surgery to repair, place and/or support tissue. Surgical constructs may include grafts and implants such as an implant incorporated into a prosthesis and/or surgical instruments such as a transfer guide for positioning one or more surgical instruments, implants and/or grafts. The grafts may include synthetic and/or biological materials, such as an allograft or autograft. The systems and methods disclosed herein may be utilized in the repair of various locations of the anatomy and various surgical procedures including repair of bones and joints associated with the anatomy A and/or the anatomic simulacra 10 such as the shoulder, foot, ankle, wrist, hand, hip, knee and spine. The surgical system 36 may be utilized to perform other orthopedic procedures, including sports medicine procedures which may be performed to repair and/or reconstruct ligament(s) and/or tendon(s) and which may include use of graft(s). Sports medicine procedures may include a rotator cuff repair and anterior cruciate ligament (ACL) and/or posterior cruciate ligament (PCL) repairs.

The surgical system 36 may include a host computer 37 and one or more client computers 38. The host computer 37 may be configured to execute one or more software programs. In implementations, the host computer 37 may be more than one computer jointly configured to process software instructions serially and/or in parallel. The computing device(s) 25 of the surgical suite 20 (FIG. 1A) may include and/or may interface with the computer(s) 37, 38. Further, the robot 27 may interface with the computers 37, 38.

The computers 37, 38 may be operable to communicate with one or more networks such as a network 39 comprised of one or more computing devices. The network 39 may be a private local area network (LAN), a private wide area network (WAN), the Internet, or a mesh network.

The host computer 37 and each client computer 38 may include one or more computer processors, memory, storage means, network devices, and input and/or output devices and/or interfaces. The input devices may include keyboards, mice and touch screens. The output devices may include monitors, speakers and printers. The memory may include UVPROM, EEPROM, FLASH, RAM, ROM, DVD, CD, a hard drive, or other computer readable medium which may store data and/or other information relating to the planning and implementation techniques disclosed herein. The computer processor(s) may be operable to individually and/or collectively execute any of the functionality disclosed herein.

The host computer 37 and each client computer 38 may be a desktop computer, laptop computer, smart phone, tablet, wearable (e.g., augmented reality) device, or any other computing device. The interface may be adapted to facilitate communication with the other systems and/or components of the network 39, which may include the various modules of the surgical suite 20 (FIG. 1A) and the kit 102 (FIG. 1C).

Each client computer 38 may be operable to communicate with the host computer 37 directly via a direct client interface or over the network 39. In another implementation, the client computers 38 may be operable to communicate with each other directly via a peer-to-peer interface.

The surgical system 36 may include, or may interface with, one or more imaging devices 40. The host computer 37 and/or client computer(s) 38 may be coupled to the imaging device(s) 40. Each imaging device 40 may be configured to capture or acquire imagery, including one or more images 41 of patient anatomy A and/or the anatomic simulacra 10 that may reside within a scan field (e.g., window) of the imaging device 40. The imagery may include two-dimensional (2D) and/or three-dimensional (3D) greyscale and/or color images 41. Various imaging devices 40 may be utilized, such as an X-ray machine, CT machine or MRI machine that may be operable to obtain one or more images of the anatomy A of the patient and/or the anatomic simulacra 10.

The client computers 38 may be operable to execute one or more software programs, including programs for controlling various surgical tools, which may include the robot 27. Each client computer 38 may be operable to access and locally and/or remotely execute a surgical (e.g., planning or guidance) environment 42. The surgical environment 42 may be a standalone software package or may be incorporated into another surgical tool. The surgical environment 42 may be configured to communicate with the host computer 37 either over the network 39 or directly through the direct client interface. In implementations, the host computer 37 may be operable to execute the surgical environment 42.

The surgical environment 42 may be operable to obtain (e.g., acquire) imagery of patient anatomy A and/or the anatomic simulacra 10, including one or more images 41. The surgical environment 42 may be operable to interact with one or more of the imaging devices 40 to capture, acquire or otherwise obtain image(s) 41 of patient anatomy A and/or the anatomic simulacra 10. The surgical environment 42 may be operable to provide a display (e.g., visualization) of one or more images 41, virtual anatomical (e.g., bone) models 43, and/or surgical device models including virtual surgical construct (e.g., implant or graft) models 44 and/or virtual surgical transfer (e.g., instrument or guide) models 45 via one or more graphical user interfaces (GUI). The anatomical model 43 may be representative of one or more bones and/or soft tissue, which may be associated with a respective joint. Each image 41, anatomical model 43, implant model 44, transfer model 45 and/or other data and information may be stored in one or more files or records according to a specified data structure. The implant model 44 may include one or more components. The implant model 44 may be associated with various implants, such as bases (e.g., base plates or trays) configured to be coupled to a respective articulation member, and bone plates configured to interconnect adjacent bones or bone fragments. The articulation member may have an articular surface dimensioned to mate with an articular surface of an opposed bone or implant. As described below, the client computers 38 may execute one or more software programs defined by the surgical environment 42.

The surgical system 36 may include at least one storage system 46, which may be operable to store or otherwise provide data to other computing devices. The storage system 46 may be a storage area network device (SAN) configured to communicate with the host computer 37 and/or the client computers 38 over the network 39. In implementations, the storage system 46 may be incorporated within, or may be directly coupled to, the host computer 37 and/or client computers 38. The storage system 46 may be configured to store various information, such as one or more computer software instructions, data, database files and configurations. In implementations, the storage system 46 may be remote (e.g., server or cloud-based storage) from the host computer 37 and/or client computers 38. The storage system 46 may be connected with the host computer 37 and/or client computers 38 through a network connection which may be wired or wireless.

In implementations, the surgical system 36 may be a client-server architecture configured to execute computer software on the host computer 37, which may be accessible by the client computers 38 using either a thin client application or a web browser executing on the client computers 38. The host computer 37 may be operable to load the computer software instructions from local storage, or from the storage system 46, into memory and may execute the computer software using the one or more computer processors. Other architectures may be utilized, including cloud computing.

The surgical system 36 may include one or more databases 47. The databases 47 may be stored at a central location, such as the storage system 46. In other implementations, one or more databases 47 may be stored at the host computer 37 and/or may be a distributed database provided by one or more of the client computers 38. Each database 47 may be a relational database configured to associate one or more images 41, anatomical models 43, implant models 44 and/or transfer models 45 to each other and/or a respective surgical plan(s) 48. Each surgical plan 48 may be associated with the anatomy of a respective patient and/or the anatomic simulacra 10. Each image 41, anatomical model 43, implant model 44, transfer model 45 and/or surgical plan 48 may be assigned a unique identifier or database entry. The database 47 may be configured to store data and other information corresponding to the images 41, anatomical models 43, implant models 44, transfer models 45 and/or surgical plans 48 in one or more database records or entries, and/or may be configured to link or otherwise associate one or more files corresponding to each respective image 41, anatomical model 43, implant model 44, transfer model 45 and/or surgical plan 48. Images 41, anatomical models 43, implant models 44, transfer models 45 and/or associated surgical plans 48 stored in the database(s) 47 may correspond to respective patient anatomies and/or the anatomic simulacra 10 from prior, planned and/or hypothetical surgical cases, and may be arranged into one or more predefined categories such as sex, age, race, ethnicity, defect category, procedure type, surgeon, and/or facility or organization.

Each image 41 and/or anatomical model 43 may include data and other information obtained from one or more medical devices or tools, such as the imaging devices 40. The anatomical model 43 may include coordinate information relating to an anatomy of the patient and/or the anatomic simulacra 10 obtained or derived from image(s) 41 captured or otherwise obtained by the imaging device(s) 40. Each implant model 44 and transfer model 45 may include geometry and/or coordinate information associated with a predefined design or a design established or modified by the surgical environment 42. The surgical environment 42 may incorporate and/or interface with one or more modeling packages, such as a computer aided design (CAD) package, to render the models 43, 44, 45 as 2D and/or 3D volumes or constructs, which may overlay one or more of the images 41 in a display window (e.g., screen) of a GUI.

The anatomical (e.g., bone or joint) model(s) 43 and/or implant model(s) 44 may be associated with a local coordinate (e.g., reference) system and/or a global (e.g., common) coordinate (e.g., reference) system. The surgical environment 42 may define the global coordinate system utilizing any of suitable technique. The global coordinate system may be associated with a set of coordinate values. The global coordinate system may include the localizer coordinate system LCS (FIG. 1A). In implementations, the global coordinate system may be representative of an anatomical position of the patient and/or the anatomic simulacra 10, which may be the same or may differ from an acquisition position associated with the image data which may be acquired by the imaging device(s) 40. The global coordinate system may be established with respect to Z (0, 0, 1), Y (0, 1, 0) and X (1, 0, 0) axes. The Z axis of the global coordinate system may correspond to a vertical direction. The X and Y axes of the global coordinate system may extend in respective horizontal directions along a horizontal plane. The global coordinate system may be established relative to one or more anatomical planes of the anatomy A and/or the anatomic simulacra 10. An orientation of the anatomical model(s) 43 relative to the global coordinate system may be representative of an anatomical (e.g., upright or vertical) position of the patient, or an anatomical position of the anatomic simulacra 10. The axes of the local and/or global coordinate systems may be established with respect to an acquisition orientation of the imagery associated with the imaging device(s) 40. The surgical environment 42 may be operable to register the anatomical model(s) 43 associated with the anatomy of a patient and/or the anatomic simulacra 10 from the respective local coordinate system to the global coordinate system. The surgical environment 42 may be operable to evaluate and/or display the anatomical model(s) 43 with respect to the local and/or global coordinate system, including establishing a surgical plan 48 and/or performing a range of motion simulation, which may be associated with one or more implant model(s) 44 placed relative to the anatomical model(s) 43.

The implant models 44 may correspond to (e.g., physical) implants and components of various configurations, shapes, sizes, procedures and/or instrumentation. The implant model 44 may be associated with a patient-specific implant for treating a single patient or particular patient associated with the anatomic simulacra 10, or may be non-patient specific (e.g., generic) for treating different patients or generic ones of the anatomic simulacra 10. Each implant may include, or may otherwise be associated with, one or more components that may be situated at a surgical site including grafts and various fixation devices such as screws, anchors, nails and suture. Each implant model 44 may correspond to a single (e.g., monolithic) component or may include two or more components that may be configured to establish an assembly. The implant model 44 may include a base (e.g., base plate or tray) coupled to an articulation member, bone plates configured to interconnect adjacent bones or bone fragments, intermedullary nails and/or suture anchors. The articulation member may have an articular surface dimensioned to mate with an articular surface of an opposed bone or implant. The implant(s), instrument(s) and/or associated component(s) may be formed of various materials, including metallic and/or non-metallic materials. Each anatomical model 43, implant model 44 and transfer model 45 may correspond to 2D and/or 3D geometry and may be utilized to generate a wireframe, mesh and/or solid construct in a display.

The transfer model(s) 45 may be associated with respective transfer devices. The transfer devices may include configurable (e.g., reusable), patient-specific and/or procedure specific devices. The transfer devices may include guides, which may be adapted to guide one or more surgical devices, including guide elements (e.g., K-wires and pins) and/or cutting instruments 35.

Each surgical plan 48 may be associated with one or more of the images 41, anatomical models 43, implant models 44 and/or transfer models 45. The surgical plan 48 may include various parameters associated with the respective images 41, anatomical models 43, implant models 44 and/or transfer models 45. The parameters may relate to bone characteristics (e.g., bone density and/or bone quality) associated with patient anatomy A and/or the anatomic simulacra 10 captured in the image(s) 41. The surgical plan 48 may include parameters including spatial information relating to relative placement and coordinate information of the selected anatomical model(s) 43, implant model(s) 44 and/or transfer model(s) 45.

The surgical plan 48 may include one or more revisions to an anatomical (e.g., bone, joint, the and/or the anatomic simulacra 10) model 43 and/or information relating to placement of an implant model 44 and/or transfer model 45 relative to the original and/or revised anatomical model 43. The surgical plan 48 may include coordinate information relating to the revised anatomical model 43 and a relative placement of the implant model 44 and/or transfer model 45 in predefined data structure(s). The surgical environment 42 may be operable to make one or more revisions to a transfer model 45 automatically or in response to user interaction with the user interface. Revisions to the anatomical model 43, implant model 44, transfer model 45 and/or surgical plan 48 may be stored in the database 47 automatically and/or in response to user interaction with the system 36.

One or more surgeons and other clinical users may be provided with a surgical environment 42 via the client computers 38 and may simultaneously access the image(s) 41, anatomical model(s) 43, implant model(s) 44, transfer model(s) 45 and/or surgical plan(s) 48 stored in the database(s) 47. Each user may interact with the surgical environment 42 to create, view, edit (e.g., modify) and/or approve various aspects of the surgical plan 48. Each client computer 38 may be configured to store local instances of the images 41, anatomical models 43, implant models 44, transfer models 45 and/or surgical plans 48, which may be synchronized in real-time or periodically with the database(s) 47. The surgical environment 42 may be a standalone software package executed on a client computer 38 or may be provided as one or more services executed on the host computer 37.

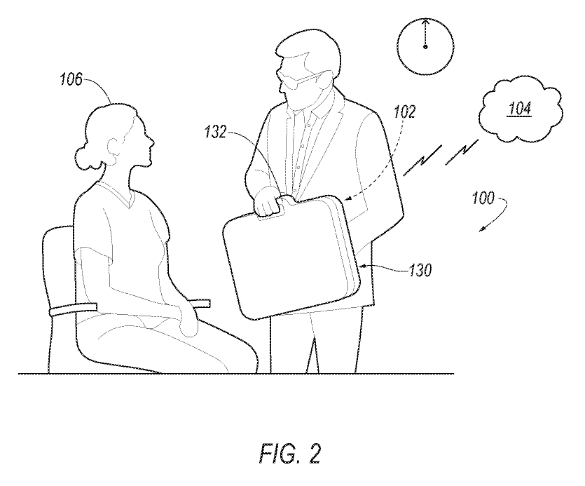

With reference to FIG. 1C, a system 100 is shown for surgical training. In one example, the system 100 may include a kit 102 and an optional remote system 104. As will be described, the kit 102 may provide surgical training, for either human or animal based surgical procedures, and may be used with the surgical suite 20. Generally, the kit 102 enables a trainee 106 (FIG. 2) to practice one or more surgical procedures or perform a surgical training procedure associated with a selected portion of the anatomy. The surgical training procedures associated with the kit 102 may comprise an arthroscopic surgical procedure, an arthroplastic surgical procedure, or may comprise both types of surgical procedures or portions thereof. The kit 102 generally includes the components necessary to perform the one or more surgical training procedures or portions thereof on the portion of the anatomy to simulate the performance of the respective surgical procedures in the field. Training and/or the results of the one or more surgical training procedures may be transmitted by the kit 102 to the remote system 104, which may include the computing devices 25, the computers 37, 38 and/or the robot 27; may be stored locally within the kit 102; and/or may be evaluated substantially in real- time either remotely or in-person. It should be noted that while the user of the kit 102 may be referred to herein as a "trainee" the kit 102 may be used by any suitable individual and/or the robot 27, and the use of the term "trainee" is not intended to limit the scope of this disclosure.

In one example, the remote system 104 may include, but is not limited to, at least one of a remote electronic device 108, a remote server 109, the computing devices 25, the computers 37, 38 and/or the robot 27, etc. In the example of the remote system 104 including the remote electronic device 108, the remote electronic device 108 may be in communication with the kit 102 to transmit and receive data from the kit 102. For example, the kit 102 may transmit data, such as a selected surgical training procedure, an image data stream of the trainee 106 as observed by a portion of the kit 102, procedure performance data associated with the surgical training procedure performed by the trainee 106, a geographical location of the kit 102, etc. The remote electronic device 108 may transmit a remote image data stream to the kit 102 to provide instructions such as instructions to perform at least a portion of a surgical training procedure, to remotely observe the surgical training procedure substantially in real-time, etc. The remote electronic device 108 may comprise any suitable electronic device, including, but not limited to, a computer, a tablet, a cellular phone, the computing devices 25, the computers 37, 38 and/or the robot 27, etc. It should be noted that while the remote electronic device 108 may be described herein as comprising a single remote device, the remote electronic device 108 may also comprise a network of remote devices, which may be in communication with the kit 102 during at least a portion of the surgical training procedure.

In the example of a remote server 109, the remote server 109 may be in communication with the kit 102 to transmit and receive data from the kit 102. For example, the kit 102 may transmit procedure performance data associated with the surgical training procedure performed by the trainee 106 to the remote server 109 for processing and analysis. The kit 102 may also receive a surgical training procedure to be performed by the kit 102 from the remote server 109.

Generally, the kit 102 may include the components necessary to perform one or more surgical procedures or portions thereof on one or more of the anatomic simulacra 110. In one example, the kit 102 may include one or more anatomic simulacra 110, a fixture 112, one or more implants 114, an instrument system 116, a cleaning system 118, an optional surgical optical system 120, one or more optional check fixture(s) 122, an optional fluid management system 124, an optional tracking system 126 and a personal electronic device 128.

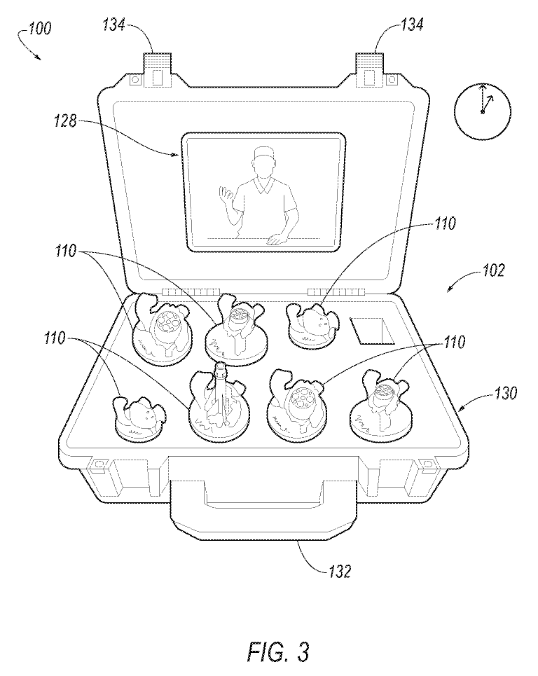

In this example, the anatomic simulacra 110, the fixture 112, the implants 114, the instrument system 116, the cleaning system 118, the surgical optical system 120, the check fixture 122, the fluid management system 124, the tracking system 126 and the personal electronic device 128 may all be contained in a case 130. With reference to FIG. 2, in one example, the case 130 may be a hard-sided or rigid case. For example, the case 130 may comprise a case commercially available from Pelican Products, Inc. of Torrance, California, USA. The case 130 may generally include a graspable portion or handle 132 for carrying the case 130, and one or more latches 134 (FIG. 3) to secure the case 130 in a closed position (FIG. 2). With reference to FIG. 3, the release of the latches 134 enables the case 130 to be moved to the opened position (FIG. 3) to enable access to the kit 102 contained within the case 130.

The one or more anatomical synthetic specimens or anatomic simulacra 110 may include a variety of polymer-based anatomical models, as shown in FIG. 3. The anatomic simulacra 110 may be used in the place of cadaveric specimens and correspond to a portion of an anatomy. It should be noted that while the anatomic simulacra 110 are described herein as comprising anatomical synthetic specimens or anatomic simulacra of a portion of a human or animal anatomy, the anatomic simulacra 110 may also be described as synthetic specimens. The anatomic simulacra 110 may be constructed using additive manufacturing techniques and systems, such as 3D printing. In other examples, the anatomic simulacra 110 or portions thereof may be cast. Thus, it should be understood that other manufacturing processes, including other additive manufacturing (AM) techniques, may be employed to form the anatomic simulacra 110. In one example, the anatomic simulacra 110 may be formed using vat photopolymerization (VPP), in which ultraviolet (UV) light may be used to cure liquid photopolymer resins. For example, the UV light may cure the photopolymer resin layer by layer, and a platform may move as more layers are built on top of one another, within a build tray. The anatomic simulacra 110 may be composed of a predetermined mixture of polymer-based materials, and the anatomic simulacra 110 may be constructed with predetermined fill patterns or densities to have different characteristics to simulate different human or animal anatomical structures. In one example, the anatomic simulacra 110 may be composed of suitable polymer-based materials, including, but not limited to silicon, photopolymer resins, etc.

Generally, the anatomic simulacra 110 may include polymer-based anatomical models that have different characteristics, including, but not limited to different densities, fracture patterns, porosities, pathology, simulated age and the like such that each of the anatomic simulacra 110 may be distinct from another one of the anatomic simulacra 110 in the kit 102 to provide a different surgical procedure experience for each of the anatomic simulacra 110. Generally, the anatomic simulacra 110 associated with the kit 102 may be polymer-based anatomical models of the same portion of the anatomy, for example, an anatomical joint. Each of the anatomic simulacra 110 may include a different characteristic such that the surgical training procedure associated with the kit 102 may be applied to different anatomical models, like a surgeon may experience in the field. In the example of FIG. 3, the anatomic simulacra 110 may comprise a plurality of synthetic glenohumeral joints, with each of the synthetic glenohumeral joints having a different characteristic. As a further example, the anatomic simulacra 110 may comprise a plurality of synthetic talocrural joints, a plurality of radiocarpal joints, a plurality of acetabulofemoral joints, a plurality of knee joints, a plurality of radioulnar joints, etc., with each of the anatomic simulacra 110 of the particular anatomical joint having a different characteristic. In certain examples, the anatomic simulacra 110 may include characteristics that are not observable upon inspection to provide a predefined training experience for the trainee 106. In addition, the kit 102 may include anatomic simulacra 110 having typical and atypical fracture patterns as a characteristic. It should be noted that while the kit 102 is described herein as including the anatomic simulacra 110 that may comprise anatomical joints, the kit 102 may also include anatomic simulacra 110 that comprise a portion of an anatomy and need not include an anatomical joint.

In one example, with reference back to FIG. 1C, each of the anatomic simulacra 110 may include a specimen attachment 110a. In one example, the anatomic simulacra 110 may each include a pin, which may be coupled to a corresponding attachment 136 of the fixture 112 to couple the anatomic simulacra 110 to the fixture 112. In other examples, the anatomic simulacra 110 may include a counterbore, which may be coupled to the attachment 136 to couple the anatomic simulacra 110 to the fixture 112. In certain examples, the anatomic simulacra 110 may be manufactured with a mounting portion, such as a disc, collar, flange or the like, which may comprise the specimen attachment 110a and/or the specimen attachment 110a may be coupled to the mounting portion. Generally, the specimen attachment 110a may be defined on or coupled to each of the anatomic simulacra 110 to enable the anatomic simulacra 110 to be coupled to the fixture 112 without interfering with the surgical training procedure.

The fixture 112 comprises any suitable device that the anatomic simulacra 110 may be coupled to for performing the surgical training procedure. For example, the fixture 112 may comprise a stand 138 that includes the attachment 136. For example, the stand 138 may comprise an L-shaped arm, which includes a receiver that engages with the pin of the anatomic simulacra 110 to elevate the anatomic simulacra 110 above a surface of a workspace. As a further example, the stand 138 may comprise a circular base, which defines a post configured to mate with the counterbore of the anatomic simulacra 110 to couple the anatomic simulacra 110 above the surface of the workspace. Generally, the stand 138 may support a respective one of the anatomic simulacra 110 in a particular orientation for carrying out the surgical procedure. It should be noted that in some examples, a portion of an interior or exterior of the case 130 may comprise the surface of the workspace such that in some examples, the case 130 may allow the surgical training procedure to be performed at any desired location and may comprise the fixture 112.

In some examples, the fixture 112 may also include a fixture attachment 140. The fixture attachment 140 may be used to attach or secure the fixture 112 to the surface of the workspace. For example, the fixture attachment 140 may comprise a suction cup, C-clamp, magnet or the like, which may cooperate with the surface of the workspace to removably secure the fixture 112 to the surface of the workspace while inhibiting rotation of the fixture 112 relative to the workspace. In certain examples, the fixture 112 may also include one or more sensing devices, which are in communication with the personal electronic device 128 to transmit data to the personal electronic device 128. For example, the fixture 112 may include one or more of torque sensors, temperature sensors, force sensors, pressure sensors, etc., which may observe the fixture 112 and the anatomic simulacra 110 coupled to the fixture 112 and generate sensor signals based thereon.

The one or more implants 114 may comprise one or more implants used in the surgical training procedure. Generally, each of the implants 114 may comprise a biocompatible implant of the type that may be used in the surgical procedure that the surgical training procedure may replicate. Thus, the implants 114 may comprise any suitable implant for use to repair or reconstruct the associated anatomic simulacra 110 in the surgical training procedure. Exemplary implants 114 include, but are not limited to, plates, suture plates, pins, screws, nails, anchors, soft tissue fixation devices, suture anchors, sutures, posts, washers, staples, darts, rails, bone cement, stems, glenoid implants, humeral head implants, patellofemoral implants, patella implants, femoral implants, fixators, wires, rings, struts, spacers, buttons, etc. The implants 114 contained in the kit 102 may comprise the implants 114 associated with both the anatomic simulacra 110 and the surgical training procedure. In addition, the implants 114 associated with the kit 102 and the anatomic simulacra 110 may comprise both implant(s) to repair the joint of the anatomic simulacra 110 and implant(s) for a revision procedure associated with the joint.

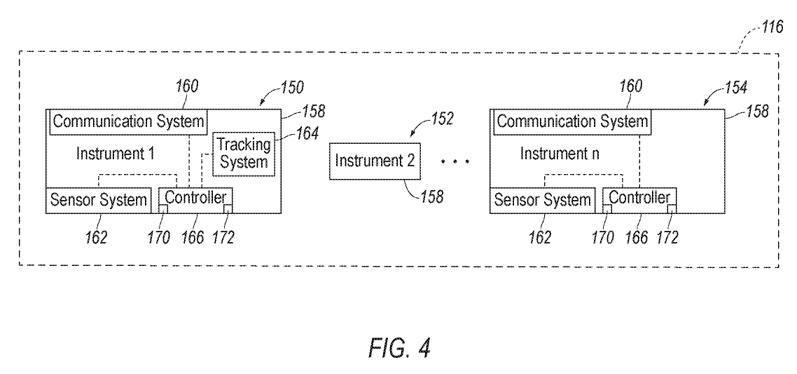

The instrument system 116 may include the tools to perform the one or more surgical procedures associated with the anatomic simulacra 110. In one example, with reference to FIG. 4, the instrument system 116 may include at least one of a first instrument type 150, a second instrument type 152 and a third instrument type 154. The first instrument type 150 may include an instrument 158, an instrument communication system 160, an instrument sensor system 162, an optional instrument tracking system 164 and an instrument controller 166.

The instrument 158 may comprise any instrument for use with the surgical procedure(s) associated with the anatomic simulacra 110 and the implants 114. For example, the instrument 158 may include a reamer, probe, curette, tissue elevator, pick, rasp, cannula, grasper, retriever, knot pusher, suture cutters, scissors, retractor, anchor inserter, suture passer, drill, obturator, screwdrivers, punch, forceps, osteotome, needle, alignment rod, rod, guide, stabilizer, stylus, calipers, cutting guide, pin driver, impactor, distractor, blade, mallet, rongeur, burr, etc.

The instrument communication system 160 may be coupled to the instrument 158. In one example, the instrument communication system 160 may be configured to wirelessly communicate data to the personal electronic device 128 and optionally the remote system 104, which may include the computing devices 25, the computers 37, 38 and/or the robot 27. In certain examples, the instrument communication system 160 may comprise a two-way communication system, which may be configured to transfer and receive data from the personal electronic device 128 and optionally the remote system 104, which may include the computing devices 25, the computers 37, 38 and/or the robot 27. In an example, the instrument communication system 160 may comprise a Bluetooth low energy (BLE) transmitter or transceiver, a near field communication (NFC) transmitter or transceiver, RF radio transmitter or transceiver, a far field communication transmitter or transceiver, a wireless communication system configured to communicate via a wireless local area network (WLAN) using IEEE 802.11 standards or by using cellular data communication, a Bluetooth transmitter or transceiver, etc. The instrument communication system 160 may also be in communication with the instrument controller 166.

The instrument sensor system 162 may include one or more sensing devices that sense observable conditions during the use of the instrument 158. The instrument sensor system 162 may include, but is not limited to, one or more of a force sensor, a torque sensor, an accelerometer, etc. The instrument sensor system 162 may be in communication with the instrument controller 166. The observations of the instrument sensor system 162 may be processed by the instrument controller 166 to determine a force applied by the user, a torque applied by the user (when tightening a screw for example), an orientation of the instrument 158, etc., which may be used by the instrument controller 166 and/or the personal electronic device 128 to determine whether the surgical training procedure was performed within predefined specifications.

The instrument tracking system 164 may be optional, and if employed, may be in communication with the instrument controller 166. Generally, the instrument tracking system 164 may determine a geographic position of the instrument 158 and may transmit the geographic position of the instrument 158 to the instrument controller 166. The instrument controller 166, in turn, may transmit the geographic location of the instrument 158 to the personal electronic device 128 using the instrument communication system 160, and a controller of the personal electronic device 128 may determine whether the instrument 158 is contained within the case 130, for example. The instrument tracking system 164 may comprise a global positioning system transceiver. In other examples, the instrument tracking system 164 may comprise a module having one or more instructions stored in memory for the instrument controller 166 to use the instrument communication system 160 to communicate a signal, such as a Bluetooth signal, to the personal electronic device 128, and the controller of the personal electronic device 128 may use the signal to determine a proximity of the instrument 158 relative to the personal electronic device 128. The personal electronic device 128 may then determine whether the instrument 158 is within the case 130.

The instrument controller 166 may include at least one processor 170 and a computer-readable storage device or media 172. The processor 170 may be any custom-made or commercially available processor, a central processing unit (CPU), a graphics processing unit (GPU), an application specific integrated circuit (ASIC) (e.g., a custom ASIC implementing a neural network), a field programmable gate array (FPGA), an auxiliary processor among several processors associated with the instrument controller 166, a semiconductor-based microprocessor (in the form of a microchip or chip set), any combination thereof, or generally any device for executing instructions. The computer readable storage device or media 172 may include volatile and nonvolatile storage in read-only memory (ROM), random-access memory (RAM), and keep-alive memory (KAM), for example. KAM is a persistent or non-volatile memory that may be used to store various operating variables while the processor 170 is powered down. The computer-readable storage device or media 172 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the instrument controller 166 in controlling features of the instrument 158.

In various examples, the instrument controller 166 may be configured to implement instructions to receive sensor signals from the instrument sensor system 162, and to transmit the sensor signals to the personal electronic device 128 and optionally to the remote system 104, which may include the computing devices 25, the computers 37, 38 and/or the robot 27, via the instrument communication system 160. In addition, the instrument controller 166 may be optionally configured to implement instructions to determine the location of the instrument 158 and to transmit signals to the personal electronic device 128 and optionally to the remote system 104 via the instrument communication system 160 regarding the location of the instrument 158.

The second instrument type 152 may comprise the instrument 158. Stated another way, the second instrument type 152 may simply comprise the instrument 158 without the instrument communication system 160, the instrument sensor system 162, the instrument tracking system 164 and the instrument controller 166. Thus, the second instrument type 152 may comprise an instrument associated with the surgical training procedure(s) associated with the anatomic simulacra 110 and the implants 114.

The third instrument type 154 may include the instrument 158, the instrument communication system 160, the instrument sensor system 162 and the instrument controller 166. Thus, the third instrument type 154 may comprise the first instrument type 150 without the instrument tracking system 164.

By providing a variety of different instrument types 150, 152, 154, the personal electronic device 128, the computing devices 25, the computers 37, 38 and/or the robot 27 may be able to evaluate the performance of the surgical training procedure and provide feedback based on the data observed. In addition, it should be noted that the kit 102 may not include each of the instrument types 150, 152, 154, but rather, the kit 102 may include one or more of the instrument types 150, 152, 154 depending upon the surgical training procedure, for example.

With reference back to FIG. 1C, the cleaning system 118 may be coupled to the case 130 and may assist in removing debris from the workspace and/or the case 130 upon completion of the surgical training procedure. In one example, the cleaning system 118 may be a vacuum, and may include a motor 180, a fan 182, a chamber 184 and a nozzle 186. The motor 180 may be in communication with the personal electronic device 128 to receive one or more control signals to drive the fan 182 to create a pressure differential to draw the debris into the nozzle 186. Alternatively, the cleaning system 118 may include a cleaning human-machine interface, such as a switch, button or the like, which may be in communication with a cleaning system controller configured to supply power to the motor 180 based on an actuation of the cleaning human-machine interface. The fan 182 may comprise any suitable fan, which may be driven by the motor 180 to create a pressure within the chamber 184 that is lower than an ambient pressure. The chamber 184 may comprise a suitable containment vessel, such as a tank or the like, which may be in fluid communication with the nozzle 186 to receive the debris that enters the nozzle 186. The nozzle 186 may be removably coupled to the case 130 so that the trainee 106 may use the nozzle 186 to clean the workspace and/or the case 130. In other examples, the cleaning system 118 may also include cleaning cloths, specimen bags, and the like. Generally, the cleaning system 118 may enable the trainee 106 to return at least the workspace to at least its original condition prior to receipt of the case 130.

The surgical optical system 120 may be optional, and may comprise a surgical imaging system, including, but not limited to a nano arthroscopy camera, an arthroscopy camera, a camera, a laparoscope, an endoscope, etc. Generally, the surgical optical system 120 may include an optical communication system 190, an imaging system 192 and an optical controller 194, which may be contained within a sterilizable and biocompatible housing. In one example, the optical communication system 190 may communicate an image data stream acquired by the imaging system 192 to the personal electronic device 128 and/or the remote system 104, which may include the computing devices 25, the computers 37, 38 and/or the robot 27.

The optical communication system 190 may be in wireless communication with the personal electronic device 128, the remote system 104, which may include the computing devices 25, the computers 37, 38 and/or the robot 27, but in other examples, the surgical optical system 120 may be in wired communication with the personal electronic device 128 and/or the computing devices 25, the computers 37, 38 and/or the robot 27 via a suitable interface, including, but not limited to a USB port, USB- C port, etc. In the example, of wireless communication, the optical communication system 190 may comprise a Bluetooth low energy (BLE) transmitter or transceiver, a near field communication (NFC) transmitter or transceiver, RF radio transmitter or transceiver, a far field communication transmitter or transceiver, a wireless communication system configured to communicate via a wireless local area network (WLAN) using IEEE 802.11 standards or by using cellular data communication, a Bluetooth transmitter or transceiver, etc.

The imaging system 192 may comprise an optical camera, including, but not limited to a high-definition optical camera, a stereo vision optical camera, a 4K optical camera, etc. Generally, the imaging system 192 may observe a portion of the surgical training procedure and may be inserted into a portion of the anatomic simulacra 110 for example, to assist the trainee 106 in visualizing the synthetic anatomy of the anatomic simulacra 110 during the surgical training procedure. The imaging system 192 may generate the image data stream based on the observation, which may be communicated to the personal electronic device 128 for display and may be transmitted to the remote system 104, which may include the computing devices 25, the computers 37, 38 and/or the robot 27, for review and/or display via the optical communication system 190.

The optical controller 194 may include at least one processor 196 and a computer-readable storage device or media 198. The processor 196 may be any custom-made or commercially available processor, a central processing unit (CPU), a graphics processing unit (GPU), an application specific integrated circuit (ASIC) (e.g., a custom ASIC implementing a neural network), a field programmable gate array (FPGA), an auxiliary processor among several processors associated with the instrument controller 166, a semiconductor-based microprocessor (in the form of a microchip or chip set), any combination thereof, or generally any device for executing instructions. The computer readable storage device or media 198 may include volatile and nonvolatile storage in read-only memory (ROM), random-access memory (RAM), and keep-alive memory (KAM), for example. KAM is a persistent or non-volatile memory that may be used to store various operating variables while the processor 196 is powered down. The computer-readable storage device or media 198 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the optical controller 194 in controlling features of the surgical optical system 120.

In various examples, the optical controller 194 may be configured to implement instructions to receive the image data stream from the imaging system 192, and to transmit the image data stream to the personal electronic device 128 and optionally to the remote system 104, which may include the computing devices 25, the computers 37, 38 and/or the robot 27, via the optical communication system 190.

Generally, the one or more check fixtures 122 may be configured to determine an accuracy of a portion of the surgical procedure or the surgical procedure performed by the trainee 106. In one example, the check fixture 122 may comprise a physical check fixture, but in other examples, the check fixture 122 may comprise an optical check fixture. In the example of a physical check fixture, the check fixture 122 may comprise one or more frames or boxes, each of which has a predefined internal surface 200. The internal surface 200 may have a configuration or dimension that may be sized to receive the anatomic simulacra 110 at a certain procedure step in the surgical training procedure. For example, the internal surface 200 may be sized and shaped to receive the anatomic simulacra 110 in the instance where the anatomic simulacra 110 has been cut, repaired or otherwise manipulated by the trainee 106 during the surgical training procedure. If the anatomic simulacra 110 after being manipulated by the trainee 106 is receivable within the internal surface 200 of the check fixture 122, the trainee 106 may receive feedback that the procedure step performed by the trainee 106 is within tolerance. If the anatomic simulacra 110 do not fit within the configuration or dimension of the internal surface 200, the trainee 106 may visually observe an issue in their performance of the surgical procedure. Thus, the check fixture 122 may provide feedback to the trainee 106 with regard to the performance of a particular procedure step in the surgical training procedure.

The check fixture 122 may be composed of a polymer-based material, and may be cast, additively manufactured, etc. In the example of the check fixture 122 being used to provide feedback on a surgical cutting procedure step, the internal surface 200 may be shaped to have a plane that has an angle that corresponds to a correct angle for the surgical cut. In some examples, the check fixture 122 may also include one or more visual markers, which enable the trainee 106 to determine whether their surgical procedure step was within a tolerance. For example, the check fixture 122 may have a green marked area for within tolerance, a red marked area for outside of tolerance, etc.

In other examples, the check fixture 122 may comprise a source of an optical check. For example, the check fixture 122 may project a shadow of a correct performance of a portion of the surgical procedure or the surgical procedure, and the trainee 106 may use the shadow to determine whether the portion of the surgical procedure or the surgical procedure was done correctly. As a further example, in the example of the check fixture 122 being used to provide feedback on a surgical cutting procedure step, the check fixture 122 may project a plane that has an angle that corresponds to a correct angle for the surgical cut so that the trainee 106 may position their manipulated or modified anatomic simulacra 110 to compare the modified anatomic simulacra 110 to the shadow to determine whether the cut on the modified anatomic simulacra 110 substantially matches the shadow projected by the check fixture 122.

The fluid management system 124 may be optional and may enable the trainee 106 to simulate an arthroscopic procedure. Thus, generally, the fluid management system 124 may include the components for providing fluid management during the surgical training procedure. In one example, the fluid management system 124 may include a pump 210, at least one cannula 212 and at least one tubing section 214. In one example, the pump 210 may comprise an electric pump, which may be battery operated and may include a controller. The pump 210 may include a human-machine interface, such as a button, switch, etc., which enables the trainee 106 to activate or deactivate the pump 210 by providing input to the controller of the pump 210. The pump 210 may be configured to supply a flow of irrigation fluid to the respective anatomic simulacra 110 during the surgical training procedure, and to remove the fluid from the respective anatomic simulacra 110. The at least one cannula 212 and the at least one tubing section 214 may each be composed of a polymer-based material, and the at least one cannula 212 may be configured to be positioned within the respective anatomic simulacra 110.

In one example, the at least one cannula 212 may comprise an inflow cannula and an outflow cannula. The inflow cannula may direct the fluid from the pump 210 into the respective anatomic simulacra 110, and the outflow cannula may remove the fluid from the respective anatomic simulacra 110 and return it to the pump 210 for disposal. The inflow cannula and the outflow cannula may each be coupled to the respective anatomic simulacra 110. The at least one tubing section 214 may include a tubing section to fluidly couple the inflow cannula to the pump 210, and another tubing second to fluidly coupled to the outflow cannula to the pump 210.

The tracking system 126 may be optional and may assist in geographically locating the kit 102 during use and transport, for example. The tracking system 126 may comprise any suitable geographical locating device, including, but not limited to a portable global positioning system (GPS) tracking device. The tracking system 126 may be in communication with the remote system 104 and may output or transmit signals indicating the location of the kit 102 in GPS coordinates. In other examples, the tracking system 126 may comprise a Bluetooth antenna, which transmits a Bluetooth signal that may be detectable by nearby devices, such as personal electronic devices outside of or external to the case 130, which may communicate the location of the kit 102 based on a proximity to the external personal electronic device and a location of the external personal electronic device.

The personal electronic device 128 may display the surgical training procedure and may also record and transmit the performance of the surgical training procedure by the trainee 106 to the remote system 104, which may include the computing devices 25, the computers 37, 38 and/or the robot 27, and/or store it for review upon receipt of the kit 102 after the surgical training procedure is complete. In one example, the personal electronic device 128 may include a display 220, a human-machine interface 222, a camera system 224, a device communication system 226 and a device controller 228. Generally, the personal electronic device 128 may comprise any suitable electronic device, including, but not limited to, a computer, a tablet, a cellular phone, etc.

The display 220 may comprise any suitable technology for displaying information, including, but not limited to, a liquid crystal display (LCD), organic light emitting diode (OLED), plasma, or a cathode ray tube (CRT). In this example, the display 220 may be an electronic display capable of graphically displaying one or more user interfaces under the control of the device controller 228. The display 220 may be in communication with the device controller 228 via a suitable communication medium. Those skilled in the art may realize other techniques to implement the display 220 in the personal electronic device 128.

The human-machine interface 222 may be in communication with the device controller 228 via a suitable communication medium. The human-machine interface 222 may be configured in a variety of ways. In some examples, the human- machine interface 222 may include a touchscreen interface 230 that may be overlaid on at least a portion of the display 220, various switches, one or more buttons, a keyboard, an audible device, a microphone associated with a speech recognition system, or various other human-machine interface devices. In one example, the touchscreen interface 230 may receive input from the user, such as a language to conduct the surgical training procedure in, a joint to perform the surgical training procedure on, a surgical procedure to perform, etc. The touchscreen interface 230 may include, but is not limited to, a resistive touchscreen panel, a capacitive touchscreen panel, a projected capacitance touchscreen panel, a surface capacitive touchscreen panel, a surface acoustic wave touchscreen panel, etc. Generally, upon the receipt input from the user, the human- machine interface 222 transmits a signal to the device controller 228. As will be discussed, the device controller 228 processes the signal, and determines the language selection, the joint selection and the procedure selection based on the user's interaction with the human-machine interface 222.

The camera system 224 may comprise an optical camera, including, but not limited to a high-definition optical camera, a stereo vision optical camera, a 4K optical camera, etc. Generally, the camera system 224 of the personal electronic device 128 may observe the surgical training procedure. The camera system 224 may be in communication with the device controller 228 via a suitable communication medium. The camera system 224 may generate an image data stream based on the observation, which may be displayed on a portion of the display 220, may be stored in a memory associated with the personal electronic device 128 and/or may be transmitted to the remote system 104 by the device communication system 226.

The device communication system 226 may be configured to wirelessly communicate data between the personal electronic device 128 and the surgical optical system 120, the cleaning system 118 and the instrument system 116. The device communication system 226 may also be configured to wirelessly communicate data to the remote system 104, which may include the computing devices 25, the computers 37, 38 and/or the robot 27. In certain examples, the device communication system 226 may comprise a two-way communication system, which may be configured to transfer and receive data from surgical optical system 120, the tracking system 126, the cleaning system 118, the instrument system 116 and optionally the remote system 104, which may include the computing devices 25, the computers 37, 38 and/or the robot 27. In an example, the device communication system 226 may comprise one or more of a Bluetooth low energy (BLE) transceiver, a near field communication (NFC) transceiver, RF radio transceiver, a far field communication transceiver, a wireless communication system configured to communicate via a wireless local area network (WLAN) using IEEE 802.11 standards or by using cellular data communication, a Bluetooth transceiver, etc. The device communication system 226 may also be in communication with the device controller 228.

The device controller 228 includes at least one processor 232 and a computer-readable storage device or media 234. The processor 232 may be any custom- made or commercially available processor, a central processing unit (CPU), a graphics processing unit (GPU), an application specific integrated circuit (ASIC) (e.g., a custom ASIC implementing a neural network), a field programmable gate array (FPGA), an auxiliary processor among several processors associated with the device controller 228, a semiconductor-based microprocessor (in the form of a microchip or chip set), any combination thereof, or generally any device for executing instructions. The computer readable storage device or media 234 may include volatile and nonvolatile storage in read-only memory (ROM), random-access memory (RAM), and keep-alive memory (KAM), for example. KAM is a persistent or non-volatile memory that may be used to store various operating variables while the processor 232 is powered down. The computer- readable storage device or media 234 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the device controller 228 in controlling the personal electronic device 128. Generally, the device controller 228 may be configured to output instructions regarding the performance of the surgical training procedure on the anatomic simulacra 110 using the instrument system 116. In various examples, device controller 228 may be configured to implement instructions of the surgical training control system 300 as described in detail below.

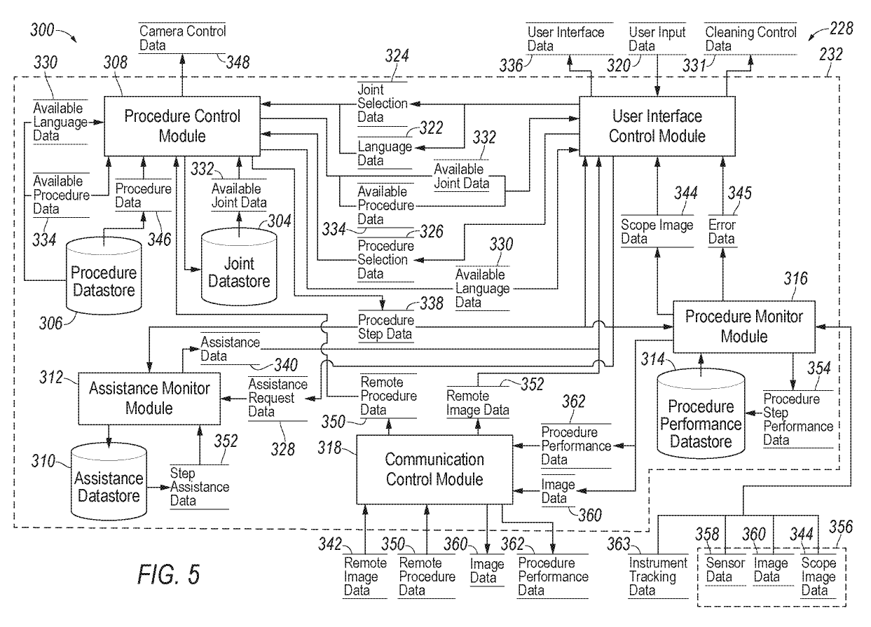

For example, as shown in more detail with regard to FIG. 5 and with continued reference to FIGS. 1-4, a dataflow diagram illustrates various examples of the surgical training control system 300, which may be embedded within the device controller 228. Various examples of the surgical training control system 300 according to the present disclosure can include any number of sub-modules embedded within the device controller 228. As can be appreciated, the sub-modules shown in FIG. 5 can be combined and/or further partitioned to similarly control the surgical training procedure. Inputs to the surgical training control system 300 may be received from the camera system 224 (FIG. 1C), the instrument system 116 (FIG. 1C), the surgical optical system 120, the human machine interface 222 (FIG. 1C), the remote system 104, received from other control modules (not shown) associated with the kit 102, received from the surgical suite 20 (FIG. 1A) and/or determined/modeled by other sub-modules (not shown) within the device controller 228. In various examples, the surgical training control system 300 includes a user interface control module 302, a joint datastore 304, a procedure datastore 306, a procedure control module 308, an assistance datastore 310, an assistance monitor module 312, a procedure performance datastore 314, a procedure monitor module 316, and a communication control module 318.

The user interface control module 302 may receive user input data 320. The user input data 320 may be received from the trainee's 106 interaction with the human-machine interface 222. In this example, the user input data 320 may comprise language data 322, joint selection data 324, procedure selection data 326, assistance request data 328 and cleaning data 329. The language data 322 may comprise input received via the human-machine interface 222 that indicates a selected language for the surgical training procedure. The joint selection data 324 may comprise input received via the human-machine interface 222 that indicates a selected joint for the surgical training procedure. The procedure selection data 326 may comprise input received via the human-machine interface 222 that indicates a selected procedure for the surgical training procedure. The assistance request data 328 may comprise input received via the human- machine interface 222 for help or assistance with the surgical training procedure. The cleaning data 329 may comprise input received via the human-machine interface 222 to activate or deactivate the motor 180 of the cleaning system 118.

The user interface control module 302 processes the user input data 320 and may set the language data 322, the joint selection data 324 and the procedure selection data 326 for the procedure control module 308. The user interface control module 302 may set the assistance request data 328 for the assistance monitor module 312. Based on receipt of the cleaning data 329, the user interface control module 302 may output cleaning control data 331. The cleaning control data 331 may comprise one or more control signals to activate or deactivate the motor 180 associated with the cleaning system 118 based on a current state of the motor 180. The current state of the motor 180 (activated or deactivated) may be stored in the media 234, for example.

The user interface control module 302 also receives as input available language data 330, available joint data 332 and available procedure data 334 from the procedure control module 308. The available language data 330 may comprise data of a list of available languages in which the instructions regarding the surgical training procedure may be output to the trainee 106 for display on the display 220. Based on the available language data 330, the user interface control module 302 may output user interface data 336.

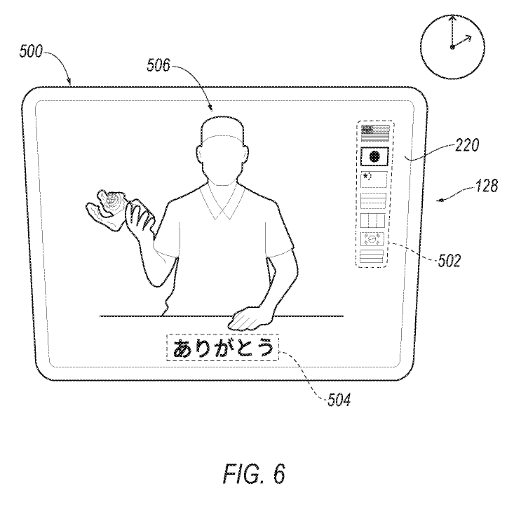

With reference to FIG. 6, the user interface data 336 may comprise a graphical user interface 500 for rendering on the display 220, which illustrates one or more icons 502 of the languages available for the surgical training procedure with the kit 102. It should be noted that the user interface data 336 may also be communicated to the computing devices 25, the computers 37, 38 and/or the robot 27 for rendering the graphical user interface 500 on a display associated with one of the computing devices 25, the computers 37, 38 and/or the robot 27, such as one of the displays 34. In one example, the icons 502 may comprise a country flag associated with the language spoken in that country, such as a Japanese flag for Japanese, a Chinese flag for Chinese, a Korean flag for Korean, a United States of America flag for English, a German flag for German, etc. The unselected languages may appear shaded or grayed out to provide a contrast between the selected language and the unselected language. In addition, a text box 504 may display a message in the selected language. The graphical user interface 500 may also include a graphical representation 506 of a surgeon with an anatomic simulacra that is associated with the kit 102 to demonstrate a particular procedural step in the surgical training procedure.

With reference back to FIG. 5, the available joint data 332 may comprise data of a list of joint(s) available for the surgical training procedure associated with the kit 102. Based on the available joint data 332, the user interface control module 302 may output user interface data 336, which may include a graphical and/or textual representation of the list of joint(s) available for rendering on the display 220. It should be noted that the user interface data 336 may also be communicated to the computing devices 25, the computers 37, 38 and/or the robot 27 for rendering the graphical and/or textual representation of the list of joint(s) available on a display associated with one of the computing devices 25, the computers 37, 38 and/or the robot 27, such as one of the displays 34. For example, the anatomic simulacra 110 contained within the kit 102 may be of more than one anatomical joint. In these instances, the trainee 106 may select via the human-machine interface 222, which anatomical joint they would like to perform the surgical training procedure on based on the user interface data 336.

The available procedure data 334 may comprise data of a list of procedure(s) available for the selected anatomical joint based on the kit 102. Based on the available procedure data 334, the user interface control module 302 may output user interface data 336, which may include a graphical and/or textual representation of the list of procedure(s) available for rendering on the display 220. It should be noted that the user interface data 336 may also be communicated to the computing devices 25, the computers 37, 38 and/or the robot 27 for rendering the graphical and/or textual representation of the list of procedure(s) available on a display associated with one of the computing devices 25, the computers 37, 38 and/or the robot 27, such as one of the displays 34. The trainee 106 may select via the human-machine interface 222, which surgical training procedure they would like to perform based on the user interface data 336.

The user interface control module 302 also receives as input procedure step data 338 from the procedure control module 308. The procedure step data 338 may comprise data of a specific procedure step to be completed by the trainee 106 during the surgical training procedure. Stated another way, the procedure step data 338 may comprise data of instructions on how to perform the procedure step of the surgical training procedure. Based on the receipt of the procedure step data 338, the user interface control module 302 may output the user interface data 336, which includes a graphical and/or textual representation of the instructions for the procedure step for rendering on the display 220. It should be noted that the user interface data 336 may also be communicated to the computing devices 25, the computers 37, 38 and/or the robot 27 for rendering the graphical and/or textual representation of the instructions for the procedure step on a display associated with one of the computing devices 25, the computers 37, 38 and/or the robot 27, such as one of the displays 34.

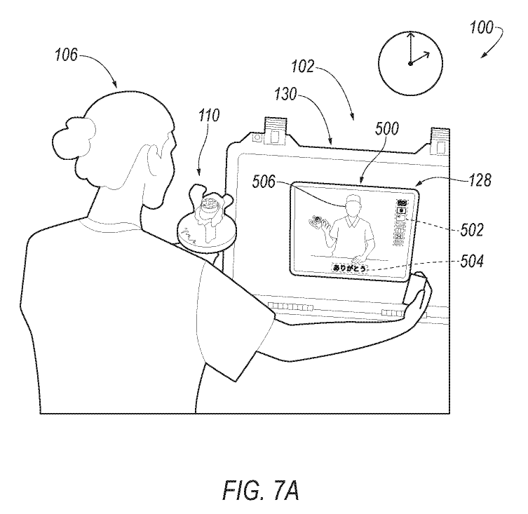

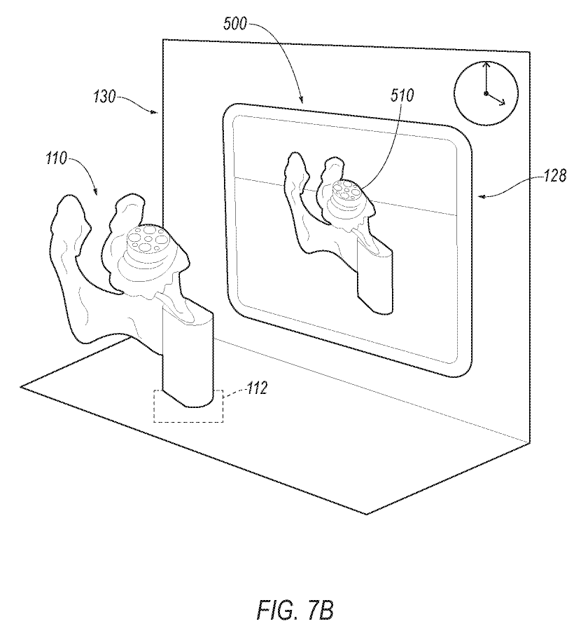

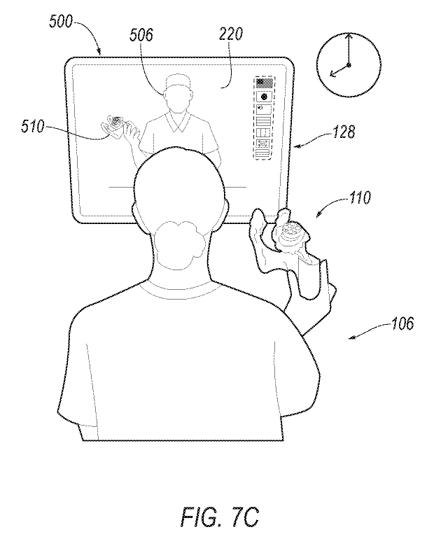

For example, with reference to FIG. 7A, the user interface data 336 may include instructions to render the graphical user interface 500, which provides the graphical representation 506 of the surgeon, and illustrates at least a portion of the procedural step. The graphical user interface 500 may also include the text box 504 displaying a message regarding the procedural step and the one or more icons 502, which illustrate the selected language for the surgical training procedure.

As a further example, with reference to FIG. 7B, the user interface data 336 may include instructions to render the graphical user interface 500, which provides the graphical representation 510 of an anatomic simulacra, and illustrates at least a portion of the procedural step performed on the graphical representation 510 of the anatomic simulacra 110. This may provide the trainee 106 with visual feedback as to whether the trainee 106 has performed the procedural step of the surgical training procedure accurately.

As another example, with reference to FIG. 7C, the user interface data 336 may include instructions to render the graphical user interface 500. The graphical user interface 500 may provide the graphical representation 510 of the anatomic simulacra with the graphical representation 506, which illustrates at least a portion of the procedural step involving one of the anatomic simulacra 110. It should be noted that while FIGS. 6 and 7A-7C are described herein as comprising the graphical representations 506, 510, in other examples, the graphical representation 506 of the surgeon may comprise a pre-recorded video stored in the procedure datastore 306 or a substantially live-stream of a remote surgeon received from the remote system 104, which may include the computing devices 25, the computers 37, 38 and/or the robot 27. The graphical representation 510 of the anatomic simulacra 110 may comprise a photograph or portion of a pre-recorded video stored in the procedure datastore 306.

With reference back to FIG. 5, the user interface control module 302 may also receive as input assistance data 340 from the assistance monitor module 312. The assistance data 340 may comprise data of assistance for the procedure step that is to be completed by the trainee 106 during the surgical training procedure. Based on the receipt of the assistance data 340, the user interface control module 302 may output the user interface data 336, which includes a graphical and/or textual representation of the assistance for the procedure step for rendering on the display 220. It should be noted that the user interface data 336 may also be communicated to the computing devices 25, the computers 37, 38 and/or the robot 27 for rendering the graphical and/or textual representation of the assistance for the procedure step on a display associated with one of the computing devices 25, the computers 37, 38 and/or the robot 27, such as one of the displays 34.

The user interface control module 302 may receive as input remote image data 342 from the communication control module 318. The remote image data 342 may comprise data of a remote observer or instructor for the performance of the surgical training procedure. Stated another way, the remote image data 342 may comprise a remote image data stream, which may be received from the remote system 104, which may include the computing devices 25, the computers 37, 38 and/or the robot 27 via the communication control module 318. Thus, in certain instances, the surgical training procedure may be observed by a remote observer or instructions to perform the procedure, such as the procedural steps, may be provided by the remote image data 342. The remote image data 342 may be live or provided substantially in real-time or may be pre-recorded and broadcast to the personal electronic device 128. Based on the receipt of the remote image data 342, the user interface control module 302 may output the user interface data 336, which includes the remote image stream for rendering on the display 220. In addition, it should be noted that the user interface data 336 may also be communicated to the computing devices 25, the computers 37, 38 and/or the robot 27 for rendering the remote image stream on a display associated with one of the computing devices 25, the computers 37, 38 and/or the robot 27, such as one of the displays 34.

The user interface control module 302 may also receive as input scope image data 344. The scope image data 344 may comprise an image data stream from the surgical optical system 120. Based on the receipt of the scope image data 344, the user interface control module 302 may output the user interface data 336, which includes the image data stream from the surgical optical system 120 for rendering on the display 220. By rendering the image data stream from the surgical optical system 120 on the display 220, the trainee 106 may observe portions of the surgical training procedure performed on the respective anatomic simulacra 110 similar to a surgical procedure in the field. In addition, it should be noted that the user interface data 336 may also be communicated to the computing devices 25, the computers 37, 38 and/or the robot 27 for rendering the image data stream from the surgical optical system 120 on a display associated with one of the computing devices 25, the computers 37, 38 and/or the robot 27, such as one of the displays 34.

The user interface control module 302 may receive error data 345 as input from the procedure monitor module 316. The error data 345 may comprise data that indicates one or more of the first instrument type 150 of the instrument system 116 have not been returned to the case 130. Based on the error data 345, the user interface control module 302 outputs the user interface data 336, which includes a graphical and/or textual representation of an error message regarding the return of the first instrument type 150 to the case 130 for rendering on the display 220. It should be noted that the user interface data 336 may also be communicated to the computing devices 25, the computers 37, 38 and/or the robot 27 for rendering the graphical and/or textual representation of an error message regarding the return of the first instrument type 150 to the case 130 on a display associated with one of the computing devices 25, the computers 37, 38 and/or the robot 27, such as one of the displays 34.

The joint datastore 304 stores data of a list of anatomical joint(s) that correspond to the anatomic simulacra 110, the implants 114 and the instrument system 116 associated with the kit 102. In certain instances, the kit 102 may contain the anatomic simulacra 110, the implants 114 and the instrument system 116 that correspond to more than one anatomical joint. In these instances, the joint datastore 304 stores the list of anatomical joint(s) or available joint data 332 to which a surgical training procedure may be performed using the kit 102. The available joint data 332 stored in the joint datastore 304 may be predefined or factory-set values.

The procedure datastore 306 stores one or more tables (e.g., lookup tables) that indicate a surgical procedure that corresponds to the available joint data 332 and the languages in which the surgical procedure is available. In certain instances, the kit 102 may contain the anatomic simulacra 110, the implants 114 and the instrument system 116 that correspond to more than one surgical procedure for the anatomical joint(s) contained within the kit 102 in more than one language. In these instances, the procedure datastore 306 stores one or more tables that provide the available language data 330, the available procedure data 334 and procedure data 346. The procedure data 346 may comprise the data to perform the surgical training procedure, which may be set forth in various procedural steps. In various examples, the tables may be defined by one or more indexes. The available language data 330, the available procedure data 334 and procedure data 346 provided by at least one of the tables indicates surgical training procedures that are available in predefined languages based on the joint selection data 324. As an example, one or more tables can be indexed by various parameters such as, but not limited to, the anatomical joint, to provide the available procedure data 334, the available language data 330 for the available procedures and procedure data 346.

The procedure control module 308 may query the joint datastore 304 and retrieve the available joint data 332 that lists the anatomical joint(s) available for the surgical training procedure. The procedure control module 308 may set the available joint data 332 for the user interface control module 302. The procedure control module 308 may receive as input the joint selection data 324. Based on the joint selected for the surgical training procedure, the procedure control module 308 may query the procedure datastore 306 and retrieve the available language data 330 and the available procedure data 334.

The procedure control module 308 may receive as input the language data 322 and the procedure selection data 326. Based on the language data 322 and the procedure selection data 326, the procedure control module 308 may query the procedure datastore 306 and retrieve the procedure data 346 for the selected surgical training procedure in the selected language. The procedure control module 308 may process the procedure data 346 and set the first step in the surgical training procedure as the procedure step data 338 for the user interface control module 302, the assistance monitor module 312 and the procedure monitor module 316. The procedure control module 308 may repeat this process for each procedural step associated with the procedure data 346 until the surgical training procedure is complete. When the surgical training procedure is complete, the procedure step data 338 may indicate the completion of the surgical training procedure. It should be noted that the procedure control module 308 may set the subsequent or sequential procedural step based on a duration of elapsed time (based on a predetermined or predefined time increment and a clock associated with the device controller 228) or based on user input to the user interface data 336 that requests the next procedural step.

Based on the procedure data 346, the procedure control module 308 may also output camera control data 348. The camera control data 348 may comprise one or more control signals for the personal electronic device 128 to activate the camera system 224 to observe the trainee 106 and the surgical training procedure performed by the trainee 106.

The procedure control module 308 may also receive as input remote procedure data 350. The remote procedure data 350 may comprise a surgical training procedure received from the remote system 104, which may include the computing devices 25, the computers 37, 38 and/or the robot 27. For example, in certain examples, the surgical training procedure may be supplied by the remote system 104 and not available locally on the device controller 228 of the personal electronic device 128. In these instances, the procedure control module 308 may receive the remote procedure data 350 via the communication control module 318. The procedure control module 308 may process the remote procedure data 350 and set the procedure step data 338 based on the procedural steps identified in the remote procedure data 350.

The assistance datastore 310 stores one or more tables (e.g., lookup tables) that indicate assistance for a particular procedural step associated with the surgical training procedures of the kit 102. The assistance datastore 310 stores one or more tables that provide step assistance data 352 based on the procedure step data 338. The step assistance data 352 may be predefined or factory-set data. In various examples, the tables may be defined by one or more indexes. As an example, one or more tables can be indexed by various parameters such as, but not limited to, the procedural step, to provide the step assistance data 352.

The assistance monitor module 312 may receive as input the assistance request data 328 and the procedure step data 338. Based on the receipt of the assistance request data 328, the assistance monitor module 312 may query the assistance datastore 310 and retrieve the step assistance data 352 based on the procedure step indicated in the procedure step data 338. The assistance monitor module 312 may process the step assistance data 352 and set the step assistance data 352 as the assistance data 340 for the user interface control module 302.

The procedure performance datastore 314 may store data of the performance of the surgical training procedure by the trainee 106. In one example, the procedure performance datastore 314 may be populated by the procedure monitor module 316 during the performance of the surgical training procedure. The procedure monitor module 316 may associate the observed performance of the surgical training procedure for a particular procedural step with the procedural step identified in the procedure step data 338 and store this as procedure step performance data 354 within the procedure performance datastore 314.

The procedure monitor module 316 may receive as input observation data 356. In one example, the observation data 356 may comprise sensor data 358, image data 360 and the scope image data 344. The sensor data 358 may comprise the sensor signals from the instrument sensor system 162 of the instrument system 116. The image data 360 may comprise an image data stream received from the camera system 224 of the personal electronic device 128. The procedure monitor module 316 may set the image data 360 for the communication control module 318. The procedure monitor module 316 may set the scope image data 344 for the user interface control module 302. In certain instances, the procedure monitor module 316 may also process the image data 360 and may determine whether the anatomic simulacra 110 contained in the image data 360 has a characteristic that matches or substantially corresponds to a characteristic stored in a datastore associated with the procedure monitor module 316, and determine whether the procedural step has been performed within a predetermined threshold based on this comparison.

The procedure monitor module 316 may also receive as input the procedure step data 338. The procedure monitor module 316 may associate the observation data 356 with the procedure step data 338, and store this as the procedure step performance data 354 within the procedure performance datastore 314. When the procedure step data 338 indicates that the surgical training procedure is complete, the procedure monitor module 316 may query the procedure performance datastore 314 and retrieve the procedure step performance data 354 associated with each of the procedure steps of the surgical training procedure. The procedure monitor module 316 may compile the procedural step performance data for each procedural step in the surgical training procedure and may set this compiled data as procedure performance data 362 for the communication control module 318. The procedure performance data 362 may comprise the observed performance of each procedure step of the selected surgical training procedure based on the observation data 356 and the procedure step data 338.

The procedure monitor module 316 may also receive as input instrument tracking data 363. The instrument tracking data 363 may comprise the data of the location of the instrument 158 received from the instrument communication system 160 of the instrument system 116. Based on the instrument tracking data 363, the procedure monitor module 316 may determine whether the instrument 158 of the first instrument type 150 is located or positioned within the case 130. If the instrument 158 is not located within the case 130, the procedure monitor module 316 may set the error data 345 for the user interface control module 302.

The communication control module 318 may receive as input the procedure performance data 362. In one example, the communication control module 318 may output the procedure performance data 362 to the remote system 104, which may include the computing devices 25, the computers 37, 38 and/or the robot 27. The communication control module 318 may receive as input the image data 360. The communication control module 318 may output the image data 360 to the remote system 104, which may include the computing devices 25, the computers 37, 38 and/or the robot 27, to enable a remote observer to observe the trainee 106 and the performance of the surgical training procedure. The communication control module 318 may also receive as input the remote image data 342 from the remote system 104, which may include the computing devices 25, the computers 37, 38 and/or the robot 27. The communication control module 318 may process the remote image data 342 and set the remote image data 342 for the user interface control module 302. The communication control module 318 may receive as input the remote procedure data 350 from the remote system 104, which may include the computing devices 25, the computers 37, 38 and/or the robot 27. The communication control module 318 may process the remote procedure data 350 and set the remote procedure data 350 for the procedure control module 308.

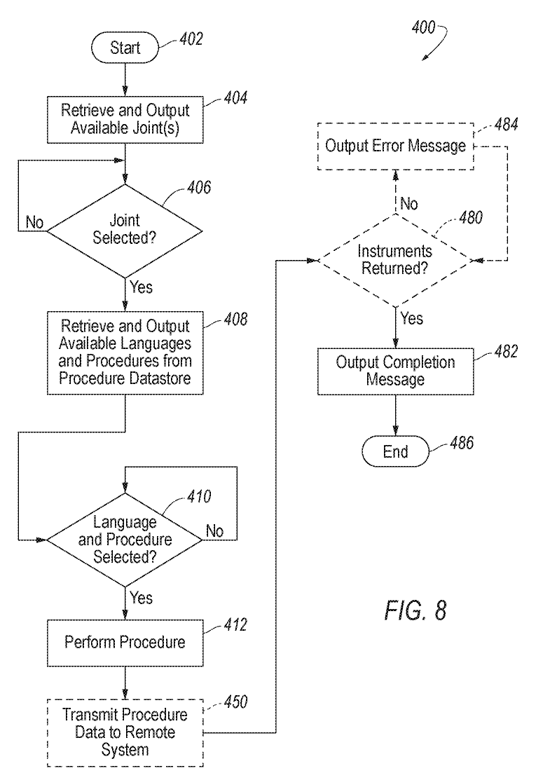

Referring now to FIGS. 8-10, and with continued reference to FIGS. 1-5, a flowchart illustrates a method 400 that can be performed by the surgical training control system 300 of FIG. 5 in accordance with the present disclosure. In one example, the method 400 is performed by the processor 232 of the device controller 228 of the personal electronic device 128. As can be appreciated in light of the disclosure, the order of operation within the method 400 is not limited to the sequential execution as illustrated in FIGS. 8-10, but may be performed in one or more varying orders as applicable and in accordance with the present disclosure. In various examples, the method 400 may run based on an activation of the personal electronic device 128 or an opening of the case 130. Generally, the tracking system 126 may transmit the GPS position of the kit 102 throughout the use of the kit 102, including before and after the surgical training procedure.

With reference to FIG. 8, the method may begin at 402. At 404, the method may output the anatomical joint(s) available within the kit 102. At 406, the method may determine whether the trainee 106 has selected an anatomical joint for the performance of the surgical training procedure. If not, the method may loop.

Once the trainee 106 has selected the anatomical joint, the method may proceed to 408. At 408, the method may output the available languages and available surgical training procedures based on the selected joint or based on the joint selection data 324. At 410, the method may determine whether the trainee 106 has selected a language and a surgical training procedure. If true, the method may proceed to 412. Otherwise, the method may loop.

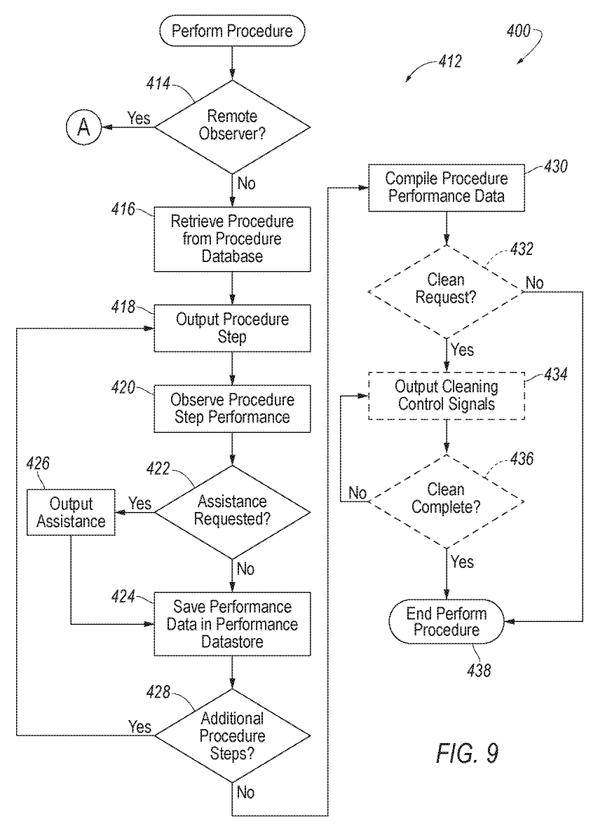

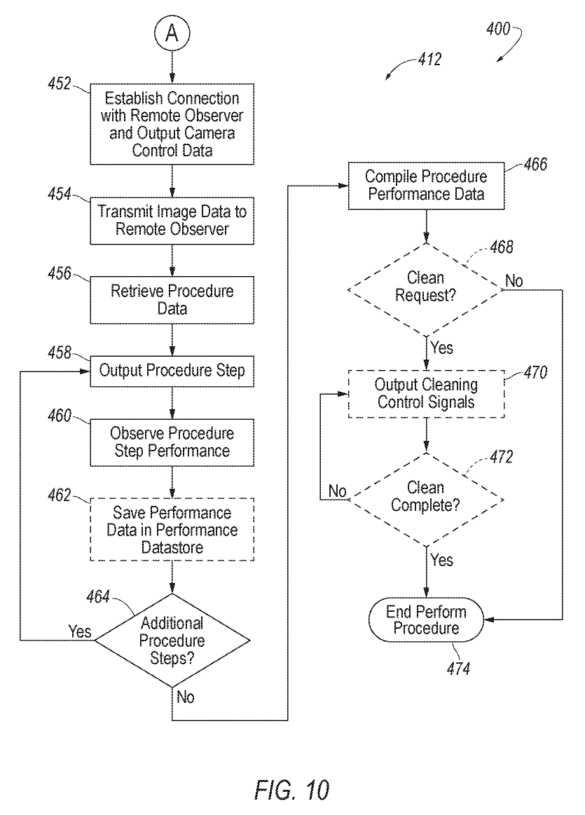

At 412, the method may perform the procedure in the procedure selection data 326. In this regard, with reference to FIG. 9, the procedure performed by the method at 412 is shown. At 414, the method may determine whether a remote observer may be present. For example, the method may determine whether remote image data 342 may be available from the device communication system 226. If the remote observer is available, the method may proceed to A on FIG. 10.

At 416, the method may retrieve the procedure data 346 from the procedure datastore 306 based on the language data 322 and the procedure selection data 326. At 418, the method may output a procedural step associated with the selected surgical training procedure. Stated another way, the method may output the user interface data 336 to render the procedural step as a graphical user interface on the display 220 based on the procedure step data 338, as also shown in FIGS. 7A-7C. The method may also communicate the user interface data 336 to the computing devices 25, the computers 37, 38 and/or the robot 27 to render the procedural step as a graphical user interface on a display associated with one of the computing devices 25, the computers 37, 38 and/or the robot 27, such as one of the displays 34. At 420, the method may observe the procedure step performance. For example, the method may receive the sensor data 358 from the instrument system 116. The method may output the camera control data 348 to control the camera system 224 to record or generate an image data stream of the trainee 106 performing the surgical training procedure. The method may also receive the scope image data 344.

At 422, the method may determine whether assistance has been requested by the trainee 106, via input to the human-machine interface 222. If false, the method may proceed to 424. Otherwise, at 426, the method may output assistance associated with the procedural step. Stated another way, the method may output the user interface data 336 to render the assistance as a graphical user interface on the display 220 based on the assistance data 340. The method may also communicate the user interface data 336 to the computing devices 25, the computers 37, 38 and/or the robot 27 to render the assistance as a graphical user interface on a display associated with one of the computing devices 25, the computers 37, 38 and/or the robot 27, such as one of the displays 34.

At 424, the method may associate the observation data 356 with the procedure step and save the associated data as the procedure step performance data 354 in the procedure performance datastore 314. At 428, the method may determine whether there are additional procedure steps in the surgical training procedure. If false, such that the surgical training procedure is complete, the method may proceed to 430. If true, the method may loop to 418.

At 430, the method may compile the procedure step performance data 354 as the procedure performance data 362 and set the procedure performance data 362 for the device communication system 226 of the personal electronic device 128. At 432, the method may optionally determine whether a request to clean the workspace and/or case 130 using the cleaning system 118 has been received via the trainee's 106 interaction with the human-machine interface 222. If true, at 434, the method may output the cleaning control data 339 to activate the motor 180 to drive the fan 182 to enable the nozzle 186 to draw debris and the like into the chamber 184 of the cleaning system 118. At 436, the method may determine whether the cleaning request has been completed based on the trainee's 106 interaction with the human-machine interface 222 to deactivate the cleaning system 118. If true, the method may end the performance of the procedure at 438 and return to 450 on FIG. 8. Otherwise, the method may loop to 434.

With reference to FIG. 10, in the instance the remote observer may be available at 414, the method may proceed at 452 to establish a connection with the remote observer at the remote system 104 via the device communication system 226 for example. The method may output the camera control data 348 to control the camera system 224 to record or generate an image data stream of the trainee 106 and the surgical training procedure. The method may receive the remote image data 342 from the remote system 104 to provide a substantially live data stream of the remote observer for rendering on the display 220. The method may also render the remote image data 342 on a display associated with one of the computing devices 25, the computers 37, 38 and/or the robot 27, such as one of the displays 34. At 454, the method may transmit the image data 360 to the remote system 104 so that the remote observer may observe the trainee 106 and the performance of the surgical training procedure substantially in real- time. At 456, the method may retrieve the procedure data 346 from the procedure datastore 306 based on the language data 322 and the procedure selection data 326. At 458, the method may output a procedural step associated with the selected surgical training procedure. Stated another way, the method may output the user interface data 336 to render the procedural step as a graphical user interface on the display 220 based on the procedure step data 338. The method may also communicate the user interface data 336 to the computing devices 25, the computers 37, 38 and/or the robot 27 to render the procedural step as a graphical user interface on a a display associated with one of the computing devices 25, the computers 37, 38 and/or the robot 27, such as one of the displays 34 The remote image data 342 may be overlayed on a portion of the user interface rendered by the user interface data 336. At 460, the method may observe the procedure step performance. For example, the method may receive the sensor data 358 from the instrument system 116. The method may also receive the scope image data 344.

At 462, the method may optionally associate the observation data 356 with the procedure step and save the associated data as the procedure step performance data 354 in the procedure performance datastore 314. At 464, the method may determine whether there are additional procedure steps in the surgical training procedure. If false, such that the surgical training procedure is complete, the method may proceed to 466. If true, the method may loop to 458.

At 466, the method may compile the procedure step performance data 354 as the procedure performance data 362 and set the procedure performance data 362 for the device communication system 226 of the personal electronic device 128. At 468, the method may optionally determine whether a request to clean the workspace and/or case 130 using the cleaning system 118 has been received via the trainee's 106 interaction with the human-machine interface 222. If true, at 470, the method may output the cleaning control data 339 to activate the motor 180 to drive the fan 182 to enable the nozzle 186 to draw debris and the like into the chamber 184 of the cleaning system 118. At 472, the method may determine whether the cleaning request has been completed based on the trainee's 106 interaction with the human-machine interface 222 to deactivate the cleaning system 118. If true, the method may end the performance of the procedure at 474 and returns to 450 on FIG. 8. Otherwise, the method may loop to 470.

At 450 on FIG. 8, the method may communicate the procedure performance data 362 to the remote system 104 using the device communication system 226. Optionally, at 480, the method may determine whether the instrument 158 having the first instrument type 150 have been returned based on data from the instrument tracking system 164. If true, the method may proceed to 482. Otherwise, at 484, the method may optionally output the user interface data 336 with instructions to render an error message on the display 220 regarding the need to return the instrument system 116 to the case 130. The method may also communicate the user interface data 336 to the computing devices 25, the computers 37, 38 and/or the robot 27 to render the error message on the display 220 regarding the need to return the instrument system 116 to the case 130 on a display associated with one of the computing devices 25, the computers 37, 38 and/or the robot 27, such as one of the displays 34.

At 482, the method may output the user interface data 336 with instructions to render a completion message to indicate that the surgical training procedure is complete and/or to return the kit 102 to a predefined location. The method may also communicate the user interface data 336 to the computing devices 25, the computers 37, 38 and/or the robot 27 to render the completion message to indicate that the surgical training procedure is complete and/or to return the kit 102 to a predefined location on a display associated with one of the computing devices 25, the computers 37, 38 and/or the robot 27, such as one of the displays 34. The method may end at 486.

Generally, once the surgical training procedure is completed, the items associated with the kit 102 such as the anatomic simulacra 110, the fixture 112, the implants 114, the instrument system 116, the cleaning system 118, the surgical optical system 120, the check fixture(s) 122, the fluid management system 124 and the personal electronic device 128 may be returned to the case 130, which may then be returned to a supplier of the kit 102. The cleaning system 118 may assist in removing any debris generated from the use of the kit 102 from the workspace such that the workspace is in the same condition as prior to the use of the kit 102.

Thus, the system 100 enables the trainee 106 to perform a surgical training procedure without the use of cadaveric components. The performance of the surgical training procedure may be evaluated by at least one of a substantially real-time evaluation by the remote observer, by an instructor that supplies the trainee 106 with the kit 102, by the remote system 104, etc. The check fixture(s) 122 may also be utilized to determine whether a portion of the surgical training procedure was performed accurately. In other examples, portions of the surgical training procedure may include contact film, pressure measurement film, contact paper or other marking film or paper, which may be evaluated to determine whether the procedural step was performed accurately. For example, the pressure measurement film maybe positioned between the implant 114 and the anatomic simulacra 110 and may be used to determine whether the implant 114 was fully secured to the anatomic simulacra 110. In one example, the camera system 224 may observe the pressure measurement film, and a module of the device controller 228 may determine, based on the observation of the camera system 224, the pressure applied between the implant 114 and the anatomic simulacra 110 to evaluate whether the implant 114 was seated on the anatomic simulacra 110. The evaluation of the surgical training procedure may also be conducted when the kit 102 is returned after use.

In addition, in certain examples, the device controller 228 of the personal electronic device 128, the computing devices 25, the computers 37, 38 and/or the robot 27 may be configured to process the image data 360 throughout the surgical training procedure and compare the processed image data to stored data to determine whether the surgical training procedure is progressing accurately. For example, the device controller 228 may process the image data 360 to identify objects and determine whether the identified objects match or substantially correspond to objects stored in a datastore. The device controller 228 may be configured to output one or more graphic, textual or audio messages based on whether the identified objects match or substantially correspond to the stored objects. In other examples, the device controller 228 may output the user interface data 336 to render on the display 220 a user interface that includes an image of the stored object. In other examples, the device controller 228 may be in communication with a projector contained within the kit 102, which may be controlled by the device controller 228 to project onto the workspace an accurately completed procedural step. In yet other examples, the device controller 228 may output one or more audio signals, such as beeps or the like, to indicate whether the procedural step of the surgical training procedure is progressing along a predefined trajectory.

Once the surgical training procedure performance has been evaluated, the results of the performance may be assigned a value or percentage, such that the trainee 106 may be compared against a predefined metric, which may be used to establish a certification associated with the surgical training procedure, a ranking with regard to the surgical training procedure, a proficiency score, etc.

It should be noted that while the assistance is described herein as being available during the performance of a procedure step associated with a surgical training procedure, assistance may be available throughout the use of the kit 102. For example, the human-machine interface 222 may include an assistance icon or the like, which enables the trainee 106 to request assistance at any point during use of the kit 102. Further, while the assistance is described herein as being available locally on the personal electronic device 128, the assistance may also be available remotely, such as from the remote system 104, which may include the computing devices 25, the computers 37, 38 and/or the robot 27.

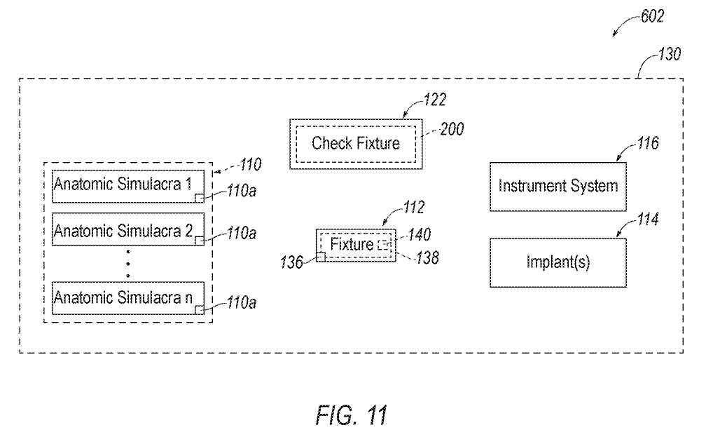

It should be noted that while the kit 102 has been described herein as including the personal electronic device 128, the kit 102 may be assembled differently. For example, with reference to FIG. 11, a kit 602 is shown. Generally, the kit 602 may include the components necessary to perform one or more surgical procedures on one or more polymer-based synthetic specimens or anatomic simulacra. In one example, the kit 602 may include the one or more anatomic simulacra 110, the one or more implants 114, the instrument system 116, the one or more check fixtures 122, and optionally, may include the fixture 112. The anatomic simulacra 110, the implants 114, the instrument system 116, the check fixture(s) 122 and the fixture 112 may all be contained in the case 130.

The kit 602 may provide surgical training, for either human or animal based surgical procedures without the use of a personal electronic device, such as the personal electronic device 128. In this example, the kit 602 may enable the trainee to practice one or more surgical procedures or perform a surgical training procedure or portion thereof associated with a selected portion of the anatomy with an in-person or live surgical trainer. In addition, the kit 602 enables the trainee to practice one or more surgical procedures with a shared personal electronic device. For example, a number of the kits 602 may be shipped or deployed with a single personal electronic device, which may be used with multiple trainees and multiple kits 602 to provide instructions regarding the surgical procedure to the multiple trainees. The surgical training procedures associated with the kit 602 may comprise an arthroscopic surgical procedure, an arthroplastic surgical procedure, or may comprise both types of surgical procedures or portions thereof. The kit 602 generally includes the components necessary to perform the one or more surgical training procedures or portions thereof on the portion of the anatomy to simulate the performance of the respective surgical procedures in the field. Training and/or the results of the one or more surgical training procedures may be verified by using the check fixture(s) 122 and/or by a trainer in real-time during the performance of the surgical training procedure.

In this regard, the check fixture(s) 122 may be used with the kit 602 to provide feedback on various steps in the surgical procedure. The check fixture(s) 122 may provide substantially instantaneous feedback as to whether the step of the procedure was performed correctly and passes (by being receivable within the internal surface 200) or was performed incorrectly and fails (by not being receivable within the internal surface 200). The check fixture 122 may also project the shadow of the correct procedural step for comparison by the trainee 106. In other examples, the in-person trainer may assess the performance of the surgical training procedure as pass or fail, or the shared personal electronic device may be used to record or transmit the performance of the surgical training procedure for remote evaluation. If the instrument system 116 includes the first instrument type 150 or the third instrument type 154, the sensor signals from the instrument sensor system 162 may be stored by the instrument controller 166 and communicated by the instrument communication system 160 subsequent to the performance of the surgical training procedure, for example, upon a return of the kit 602 to the supplier of the kit 602.

Thus, the present disclosure may be practiced in conjunction with any surgical procedure that would benefit from the use of printed synthetic specimens or anatomic simulacra, and the surgical procedures described herein are merely examples according to the present disclosure. Further, it should be noted that many alternative or additional functional relationships or physical connections may be present in an example of the present disclosure. In addition, while the figures shown herein depict an example with certain arrangements of elements, additional intervening elements, devices, features, or components may be present. It should also be understood that the drawings are merely illustrative and may not be drawn to scale.

As used herein, the term "axial" refers to a direction that is generally parallel to or coincident with an axis of rotation, axis of symmetry, or centerline of a component or components. For example, in a cylinder or disc with a centerline and generally circular ends or opposing faces, the "axial" direction may refer to the direction that generally extends in parallel to the centerline between the opposite ends or faces. In certain instances, the term "axial" may be utilized with respect to components that are not cylindrical (or otherwise radially symmetric). For example, the "axial" direction for a rectangular housing containing a rotating shaft may be viewed as a direction that is generally parallel to or coincident with the rotational axis of the shaft. Furthermore, the term "radially" as used herein may refer to a direction or a relationship of components with respect to a line extending outward from a shared centerline, axis, or similar reference, for example in a plane of a cylinder or disc that is perpendicular to the centerline or axis. In certain instances, components may be viewed as "radially" aligned even though one or both of the components may not be cylindrical (or otherwise radially symmetric). Furthermore, the terms "axial" and "radial" (and any derivatives) may encompass directional relationships that are other than precisely aligned with (e.g., oblique to) the true axial and radial dimensions, provided the relationship is predominantly in the respective nominal axial or radial direction. As used herein, the term "about" denotes within 15% to account for manufacturing tolerances. In addition, the term "substantially" denotes within 15% to account for manufacturing tolerances.

As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

The present disclosure may be described herein in terms of functional and/or logical block components and various processing steps. It should be appreciated that such block components may be realized by any number of hardware, software, and/or firmware components configured to perform the specified functions. For example, the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that the present disclosure may be practiced in conjunction with any number of systems, and that the systems described herein are merely examples.

For the sake of brevity, conventional techniques related to signal processing, data transmission, signaling, control, machine learning models, image analysis, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in the present disclosure.

Unless otherwise expressly indicated herein, all numerical values indicating mechanical/thermal properties, compositional percentages, dimensions and/or tolerances, or other characteristics are to be understood as modified by the word "about" or "approximately" in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean "at least one of A, at least one of B, and at least one of C."

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A kit for a surgical training procedure, comprising:
at least one polymer-based anatomic simulacra that corresponds to a part of an anatomy; and
at least one instrument configured to perform at least a portion of a surgical training procedure on the at least one polymer-based anatomic simulacra.

2. The kit of claim 1, wherein the at least one polymer-based anatomic simulacra comprises a plurality of anatomic simulacra and each anatomic simulacra of the plurality of anatomic simulacra has at least one characteristic.

3. The kit of claim 2, wherein the at least one characteristic is selected from the group comprising a density, a porosity, a simulated age, a fracture pattern, a pathology and combinations thereof.

4. The kit of claim 1, further comprising:
at least one check fixture configured to determine an accuracy of the surgical training procedure.

5. The kit of claim 1, wherein the at least one instrument comprises a plurality of instruments, with one of the plurality of instruments including a sensor system configured to observe the one of the plurality of instruments.

6. The kit of claim 1, further comprising:
a personal electronic device having a processor configured to output instructions to a display to perform at least a portion of a surgical training procedure on the at least one anatomic simulacra using the at least one instrument.

7. The kit of claim 6, wherein the personal electronic device includes the display, and the processor is configured to output the instructions on the display.

8. The kit of claim 6, further comprising a remote system configured to communicate with the personal electronic device, and the remote system includes the display.

9. The kit of claim 8, wherein the remote system comprises at least one of a remote personal electronic device, a computing device associated with a surgical system and a robot.

10. The kit of claim 6, further comprising:
a surgical optical system configured to communicate with the personal electronic device and to output an image data stream during the surgical training procedure, and the processor is configured to output the image data stream from the surgical optical system on the display.

11. The kit of claim 1, further comprising:
a cleaning system configured to remove debris associated with the surgical training procedure.

12. The kit of claim 1, further comprising:
a fluid management system configured to irrigate the at least one anatomic simulacra during the surgical training procedure.

13. A system for surgical training, comprising:
a kit including at least one anatomic simulacra that corresponds to a part of an anatomy, at least one instrument and a personal electronic device having a processor configured to output instructions to perform at least a portion of a surgical training procedure on the at least one anatomic simulacra using the at least one instrument; and
a remote system configured to communicate with the personal electronic device.

14. The system of claim 13, wherein the remote system is configured to communicate an image data stream to the personal electronic device, and the processor is configured to output the image data stream on a display associated with the personal electronic device as the instructions regarding the surgical training procedure.

15. The system of claim 13, wherein the remote system comprises at least one of a remote personal electronic device, a computing device associated with a surgical system and a robot, and the remote system includes a display, and the remote system is configured to display the instructions.

16. A method for surgical training, comprising:
providing at least one anatomic simulacra that corresponds to a part of an anatomy and at least one instrument configured to perform at least a portion of a surgical training procedure on the at least one anatomic simulacra;
retrieving, by a controller, the surgical training procedure based on the at least one anatomic simulacra;
outputting, by the controller, the surgical training procedure for display on a display; and
observing, by the controller, a performance of the surgical training procedure.

17. The method of claim 16, wherein the retrieving the surgical training procedure based on the at least one anatomic simulacra further comprises:
receiving, by the controller, a joint selection associated with the at least one anatomic simulacra;
retrieving, by the controller, at least one available language and at least one available surgical training procedure based on the joint selection; and
receiving, by the controller, a language selection and a selection of the surgical training procedure.

18. The method of claim 17, wherein the outputting the surgical training procedure for display on a display further comprises:
outputting each procedural step associated with the surgical training procedure on the display.

19. The method of claim 17, wherein the observing the performance of the surgical training procedure further comprises:
receiving, by the controller, observation data from at least one of a sensing system and a camera system for each procedural step;
associating the observation with the procedural step; and
storing the associated data as procedure step performance data in a datastore.

20. The method of claim 17, wherein the outputting the surgical training procedure for display on a display further comprises:
outputting the surgical training procedure for display on a display associated with at least one of a personal electronic device, a computing system of a surgical system, and a robot.
